(19) United States
(12) Patent Application Publication
(10) Pub. No.: US 2017/0181427 A1
(43) Pub. Date: Jun. 29, 2017

(54) CONTROLLED RELEASE AGROCHEMICAL DELIVERY UNITS, THEIR MANUFACTURE AND USE

(71) Applicants: Uri Shani, Tel Aviv (IL); Matti Ben-Moshe, Reut (IL); Zach Barnea, Jerusalem (IL); Ashner Vitner, Jerusalem (IL); Zvi Miller, Kiryat Tivon (IL); Nitay Lemberger, Jerusalem (IL); Eran Segal, Hulda (IL)

(72) Inventors: Uri Shani, Tel Aviv (IL); Matti Ben-Moshe, Reut (IL); Zach Barnea, Jerusalem (IL); Ashner Vitner, Jerusalem (IL); Zvi Miller, Kiryat Tivon (IL); Nitay Lemberger, Jerusalem (IL); Eran Segal, Hulda (IL)

(73) Assignee: Adama Makhteshim Ltd., Airport City (IL)

(21) Appl. No.: 15/386,407

(22) Filed: Dec. 21, 2016

Related U.S. Application Data
(60) Provisional application No. 62/271,862, filed on Dec. 28, 2015.

(51) Int. Cl. A01N 25/34; A01N 25/10

(52) U.S. Cl. CPC A01N 25/34; A01N 25/10

(57) ABSTRACT

Disclosed is an agrochemical delivery unit comprising an impermeable cell which is a cell made of material that is impermeable to water; an agrochemical within the impermeable cell; and a wick comprising a hydrogel, said wick having a portion located within the impermeable cell and a portion located outside of the impermeable cell. Also disclosed is an agrochemical delivery unit comprising (a) a cell comprising two or more cell wall segments wherein at least one segment is impermeable to water and at least one segment is permeable to water; and (ii) an agrochemical within the cell. The invention provides methods of making and using the units.

This application claims priority of U.S. Provisional Application No. 62/271,862, filed Dec. 28, 2015, the entire content of which is hereby incorporated by reference herein.

Throughout this application, various publications are referenced, including referenced in parenthesis. Full citations for publications referenced in parenthesis may be found listed at the end of the specification immediately preceding the claims. The disclosures of all referenced publications in their entireties are hereby incorporated by reference into this application in order to more fully describe the state of the art to which this invention pertains.

### BACKGROUND OF THE INVENTION

Fertilizer is most often applied as a single or formulated (N-P-K) solid, granule or powder, or as a liquid, to an area to be fertilized. In general, a fertilizer may be a water-soluble fertilizer or a “slow release” fertilizer. The water-soluble fertilizers are generally less expensive than slow-release fertilizers but they have the disadvantage of leaching nutrients very quickly into and through the soil. Throughout the years a variety of techniques have been developed for delivering nutrients to growing plants and for controlling the release of nutrients from a fertilizer source.

Controlled release fertilizers are designed to release nutrients to soil over an extended period of time, which is more efficient than multiple applications of water-soluble fertilizers. Various controlled release techniques are known, for example relatively thick encapsulating coatings, in which release is governed mainly by rupture of the coat. (for example Osmocote®, Everris, ICL).

Journal of Applied Polymer Science 2006, 3230-3235, discloses fertilizer granules (slow release granules) which are coated with gel.

U.S. Pat. No. 3,304,653 discloses a device with a wick to deliver fertilizer.

EP0438356 discloses a device for releasing soluble fertilizers to a humid soil, in a controlled and prolonged way, comprising: an enclosure with one opening containing a dry mixture of materials including at least one soluble component to be released into said humid soil; at least one component being a water absorbing finely dispersed material that serves as a thickener capable to reduce the hydraulic conductivity to water to less than one millimeter per day; the soluble component to be released being adequately selected in quantity and composition to leave a significant undissolved portion upon the initial wetting of the content of said device; said mixture being enclosed in part by a water impermeable membrane and in part by stagnation zones which act as if they were impermeable; said combination of impermeable membranes and stagnation zones having one opening in the enclosure allowing water flow into the volume in said enclosure, the area of said opening in the enclosure not exceeding one fifth of the cross-section of the enclosure. However, this device requires an enclosure that withstands the high osmotic pressure that develops inside. This device also requires a water absorbing component to be mixed with a dry mixture of fertilizers and has major drawbacks limiting the repeatable performance of the device due to entrapment of air bubbles between the enclosure opening and the fertilizer source. Furthermore, the device will have very limited functionality in dry soil or in all cases of poor contact between the enclosure opening and the soil.

EP0628527 discloses a product comprising a delayed controlled release product comprising: (a) a core comprising a water soluble active ingredient and (b) a first coating layer on the surface of the core (a) and the said layer has ability to release the active ingredient at a controlled rate; and (c) a second coating layer encapsulating (a) and (b) having a low water vapor transmission rate; whereby said second coating layer (c) causes substantial release of the active ingredient to be delayed for at least four weeks from initial exposure, of the product to moisture.

CN102424640 discloses fertilizers comprise chemical fertilizer granules, controlled-release inner film, and water-retaining outer film. The inner film is formed from carrageenan and soluble K salt or NH4 salt, and the outer film is formed from super absorbent polymer (SAP) such as acrylate-grafted starch, grafted CM-cellulose, polyacrylic acid, or polyacrylamide. The title products have the water-adsorbing/retaining, sustained-release, and soil-conditioning effects.

U.S. Pat. No. 5,147,442 and U.S. Pat. No. 6,500,223 disclose granules of fertilizer coated with a resin film.

U.S. Pat. No. 5,560,768 discloses encapsulated slow-release fertilizers wherein release is governed by the rate of water permeation through a polymeric or copolymeric membrane of the water-proofing material, and by the rate of fertilizer diffusion away from each coated particle into the surrounding soil.

However, these methods are limited by the amount of fertilizer that can be loaded to a single fertilizer source. Additionally, these methods are complex to provide different N-P-K ratios Furtheimore, these methods are limited and susceptible to defects in the fertilizer particulate surface.

WO 2009/023203 discloses a device for delivery of water and at least one further compound, the device comprising: at least one first part containing at least one first compound; at least one second part substantially surrounding said first part, the second part being at least partially permeable to water and to the or at least one first compound; and at least one third part substantially surrounding said second part, the third part including a water absorbent material.

Furthermore, excessive application of agrochemicals has adverse effects on the environment and is costly for farmers (Shaviv and Mikkelsen 1993). Many application methods have the risk of exposing humans to toxic chemicals. For example, operators, field entrants and nearby communities can be exposed to chemicals though handling, contamination of drinking water, and contamination of agricultural produce harvested prior to required post-harvest picking intervals. Non-target organisms can similarly be affected when PPPs are applied using the above-identified methods. Additionally, many soils and climates are not suitable for growing crops (Habarurema and Steiner, 1997; Nicholson and Farrar, 1994).

Thus, there is a continuing need for economical, universal, and efficient application and release of fertilizers and other agrochemicals for improving plant growth. It would be advantageous to have such a system that is, e.g., minimally dependent on ambient moisture and temperature. It would be advantageous to have system providing, e.g., high loading of agrochemicals in a unit for delivery to a plant. It would be advantageous to have a system, e.g., having a unit that is not dependent on its spatial orientation in a plant growth environment.

### SUMMARY OF THE INVENTION

This invention provides an agrochemical delivery unit comprising:
a) an impermeable cell which is a cell made of material that is impermeable to water;
b) an agrochemical within the impermeable cell; and
c) a wick comprising a hydrogel, said wick having a portion located within the impermeable cell and a portion located outside of the impermeable cell.

In an embodiment, the agrochemical delivery unit comprises:
a) an impermeable cell;
b) an agrochemical within the impermeable cell; and
c) a wick having a portion located within the impermeable cell in contact with the agrochemical, and a portion located outside the impermeable cell for contact with media outside of the impermeable cell;
arranged so as to permit controlled release of the agrochemical through the wick from inside the impermeable cell to media outside of the impermeable cell.

In some aspects, the invention provides an agrochemical delivery method comprising distributing a multitude of agrochemical delivery units to plant growth medium, wherein the units individually comprise:
a) a water impermeable cell;
b) an agrochemical within the cell;
c) a wick located partially within and partially outside the cell; and
wherein the unit provides extended controlled delivery of the agrochemical from the cell via the wick.

In some aspects, the present invention provides a process of making an agrochemical delivery unit comprising: creating a cell by encapsulating an agrochemical into a non-permeable polymeric cell equipped with a wick positioned party within and partly outside the cell such that the at least one agrochemical is released through the wick in a controlled manner after it is in contact with water.

This invention also provides an agrochemical delivery unit comprising:
a) a cell comprising two or more cell wall segments wherein at least one segment is impermeable to water and at least one segment is permeable to water; and
b) an agrochemical within the cell.

In an embodiment, the agrochemical delivery unit comprises:
a) a cell comprising two or more cell wall segments wherein at least one segment is impermeable to water and at least one segment is permeable to water; and
b) an agrochemical within the cell;

arranged so as to permit controlled release of the agrochemical through the at least one permeable segment of the cell from inside the cell to media outside of the cell.

In some aspects, the invention provides an agrochemical delivery method comprising distributing a multitude of agrochemical delivery units to plant growth medium, wherein the units individually comprise:
a) a cell comprising two or more cell wall segments wherein at least one segment is impermeable to water and at least one segment is permeable to water; and
b) an agrochemical within the cell;
wherein the unit provides extended controlled delivery of the agrochemical from the cell via the at least one permeable segment of the cell.

In some aspects, the present invention provides a process of making an agrochemical delivery unit comprising: creating a cell comprising two or more cell wall segments wherein at least one segment is impermeable to water and at least one segment is permeable to water and encapsulating an agrochemical into the cell such that the at least one agrochemical is released through the at least one permeable segment of the cell in a controlled manner after it is in contact with water.

In some aspects of the invention, the delivery method comprises distributing a multitude of agrochemical delivery units to plant growth medium. In some aspects of the invention, the units are added to the plant growth medium at one or more depths below the medium surface. In some aspects of the invention, the units are added at a depth of 1-50 cm. In some aspects of the invention, the units are added to the growth medium in a concentration of about 1 to 50, 5-50, or 10-30 units per square meter.

### BRIEF DESCRIPTION OF THE DRAWINGS

FIG. 1. Potassium release rates as function of number of fiber for A-112 (112 fibers) and A-56 (56 fibers) sachets. FIG. 2. Potassium release rates as function of fiber density for of A-300, A-90, A-70 and A-60 sachets.

FIG. 3. Potassium release rates of A-112 (fibers) and A-112 HG (fibers saturated with hydrogel).

FIG. 4. Potassium release rates in irrigated soil of A-56D (dry powder) and A-56W (wet paste) sachets.

FIG. 5. Potassium release rates of A-1.2 (1.2 g) and A-2.2 (2.2g) sachets.

FIG. 6. Potassium chloride release rates from variable fertilizer mixture (A-60- solely K), (A-60-N & K) and (A-60-P & K).

FIG. 7. Potassium release rates in irrigated soil of A-56D and A-112D sachets. FIG. 8A. Released rate of nitrogen (N) and potassium (K) as a function of time.

FIG. 8B. Release rate over time under variable soil moisture. FIG. 9. Root penetration photograph.

FIG. 10. A rectangular A-112 sachet with potassium chloride fertilizer and cotton fiber net.

FIG. 11. Triangular sachet filled with urea and containing a single cotton wick.

FIG. 12. Rectangular A-112 sachet filled with potassium chloride fertilizer and cotton fiber net dipped in hydrogel.

FIG. 13. Sachet filled with diammonium phosphate and cotton fiber net dipped in hydrogel.

FIG. 14. An agrochemical delivery unit having an impermeable cell and multiple wicks, each of the wicks having two protions inside of the impermeable cell and three portions outside of the impermeable cell.

FIG. 15. Examples of delivery unit having an impermeable cell and conduits.

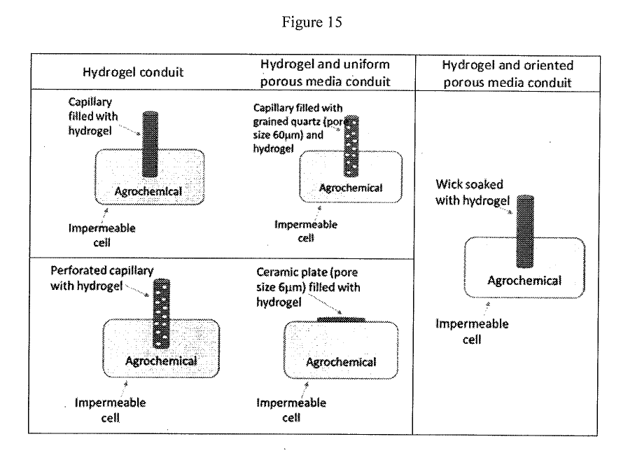

FIG. 16. 1 gram and 4 grams agrochemical delivery unit having an impermeable cell and multiple wicks.

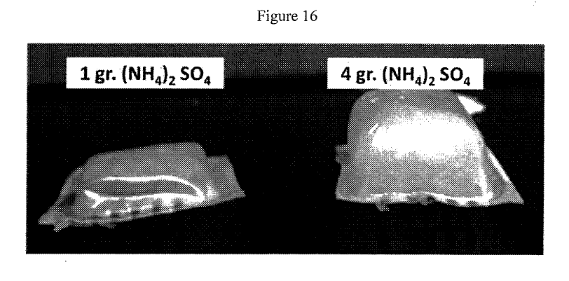

### DETAILED DESCRIPTION OF THE INVENTION

The invention provides an agrochemical delivery unit comprising:
a) an impermeable cell which is a cell made of material that is impermeable to water;
b) an agrochemical within the impermeable cell; and
c) a wick comprising a hydrogel, said wick having a portion located within the impermeable cell and a portion located outside of the impermeable cell.

In an embodiment, the agrochemical delivery unit comprises:
a) an impermeable cell;
b) an agrochemical within the impermeable cell; and
c) a wick having a portion located within the impermeable cell in contact with the agrochemical, and a portion located outside the impermeable cell for contact with media outside of the impermeable cell;

arranged so as to permit controlled release of the agrochemical through the wick from inside the impermeable cell to media outside of the impermeable cell.

In some aspects, the portion of the wick located outside the cell comprises a hydrogel. In some aspects, the portion of the wick located within the cell does not comprise a hydrogel. In some embodiments, the portion of the wick which is not in contact with the agrochemical comprises a hydrogel.

In some aspects of the invention, two or more portions of the wick are outside of the impermeable cell. In another aspect, two or more portions of the wick are in contact with the agrochemical.

In some aspects, the agrochemical is released from the cell only through the wick.

In some embodiments, the unit comprises more than one impermeable cells. In some aspects of the invention, the unit comprises two or more impermeable cells. In some embodiments, the unit comprises 2-5 impermeable cells. In some embodiments, the unit comprises 2, 3, 4, 5, 6, 7, 8, 9, 10 or more than 10 impermeable cells.

In some aspects of the invention, the unit comprises two or more agrochemicals.

In some embodiments, the agrochemical is fertilizer compound. In some embodiments, the units comprise one fertilizer compound. In some embodiments, the units comprise two fertilizer compounds. In some embodiments, the units comprise three fertilizer compounds. In some embodiments, the units comprise more than three fertilizer compounds.

In some embodiments, the fertilizer compound comprises nitrogen, potassium, phosphate or any of a combination thereof.

In some embodiments, the units comprise one to three fertilizer compounds, such that the total N, P, and/or K content as (NH₄)₂SO₂, NH4H2PO₄, and KCl in the medium as part of the units is about 5-50, 1-10, and 5-150 g/m², respectively.

In some embodiments, the units comprise three fertilizer compounds, such that the total N, P, and

K content as (NH₄)₂SO₂, NH₄H₂PO₄, and KCl in the medium as part of the units is about 25, 5, and 30 g/m², respectively.

In some embodiments, the fertilizer compound is a synthetic fertilizer.

In some embodiments, the fertilizer compound is a micronutrient such as for example boron, iron, cobalt, chromium, copper, iodine, manganese, selenium, zinc or molybdenum.

In some embodiments, the fertilizer compound is PO₄, NO₃, (NH₄)₂SO₂, NH₄H₂PO₄, and/or KCl. In some embodiments, the fertilizer compound comprises multiple fertilizer compounds which include PO₄, NO₃, (NH₄)₂SO₂, NH₄H₂PO₄, and/or KCl.

In some embodiments each of the two or more separate impermeable cells, independently, contains a different agrochemical or a different combination of agrochemicals.

In a specific embodiment, the unit is arranged so as to permit controlled release of the agrochemical through the wick from inside the impermeable cell to media outside of the impermeable cell.

In another embodiment, the agrochemical is dry prior to use, or prior to use of the unit the agrochemical is a paste containing water, a solution, a concentrated solution, a saturated solution, or a dispersion.

In some embodiments, two or more sheets are sealed together at or near their edges to form each impermeable cell. In a specific embodiment, three sheets sealed together to form two impermeable cells.

In a specific embodiment, the same wick is in contact with the agrochemical in each different impermeable cell, such that a different portion of the wick is in contact with the agrochemical of each impermeable cell.

In some aspects of the invention, the unit has only one wick. In some aspects of the invention, the unit has 2-100 wicks. In some aspects of the invention, the wick comprises a fiber strand.

In some aspects of the invention, the unit has 1-10, 1-20, or 1-100 wicks.

In some aspects of the invention, the wick comprises a fiber material. In some aspects of the invention, the one wick comprises a fiber mesh. In some aspects of the invention, the wick comprises cotton or other cellulose fiber, ceramic, or glass-based fiber. In some aspects of the invention, the wick comprises a porous material possessing capillary structure. In some aspects of the invention, the wick comprises a micro-porous material. In some aspects of the invention, the wick comprises a macro-porous material.

In some aspects of the invention, the wick comprises fiber having a density of about 10-100 mg/meter. In some aspects of the invention, the wick comprises fiber having a density of about 10-20 mg/meter. In some aspects of the invention, the wick comprises fiber having a density of about 50-100 mg/meter. In some aspects of the invention, the wick comprises about 1-500 fibers. In some aspects of the invention, the wick comprises about 10-200 fibers.

In some aspects of the invention, the wick is 0.1-10 cm in length. In some aspects of the invention, the wick is 1-5 cm in length. In some aspects of the invention, the wick is 2.5 cm in length. In some aspects of the invention, the wick is 1 μm to 200 μm in diameter. In some aspects of the invention, the wick is 50 μm to 100 μm in diameter. In some aspects of the invention, the wick is 80 μm in diameter. In some aspects of the invention, the wick comprises 1-200 non-woven filaments. In some aspects of the invention, the wick comprises 50-150 non-woven filaments. In some aspects of the invention, the wick comprises 100 non-woven filaments.

In some aspects of the invention, the cell comprises a biodegradable film. In some aspects of the invention, the cell comprises a biodegradable polymer.

In some embodiments, the cell is formed and defined by at least two component sheets that are adjoined at or near their edges and that partially enclose the wick.

In some embodiments, the cell comprises a polyester. In some embodiments, the cell comprises a polylactic acid. In some embodiments, the cell comprising polylactic acid further comprises urea. In some embodiments, the cell comprises polylactic acid sheets.

In another embodiment the cell comprises water soluble polymer. In a specific embodiment, the cell comprises poly vinyl alcohol.

In some aspects of the invention, the hydrogel comprises a super absorbent polymer (SAP). In some aspects of the invention, the SAP comprises a natural super absorbent polymer (SAP), a poly-sugar SAP, a semi-synthetic SAP, a fully synthetic SAP, or any combination thereof. In some aspects of the invention, the unit the hydrogel comprises a synthetic hydrogel, a natural carbohydrate hydrogel, or a pectin or protein hydrogel, or any combination thereof. In some aspects of the invention, the hydrogel comprises acrylamide, an acrylic derivative, or any combination thereof.

In some aspects of the invention, the cell comprises one or more of polyethylene, polypropylene, or polyester. In some aspects of the invention, the cell comprises one or more of a polylactic acid, a polyhydroxyalkanoate, a polyhydroxybutyrate, or a polyhydroxyvalerate. In some aspects of the invention, the cell comprises a thermoplastic starch, cellulose acetate, or other cellulose-based material. In some aspects of the invention, the cell comprises polycaprolactone, polyglycolide, polydioxanone, or any combinations or copolymers thereof.

In some embodiments, the wick is coated with the hydrogel. In other embodiments, the wick is saturated with the hydrogel. In some embodiments, the wick is polyester fiber. In some embodiments, the wick is polypropylene fiber.

In some embodiments, the natural carbohydrate hydrogel comprises agar, cellulose, chitosan, starch, hyaluronic acid, a dextrine, a natural gum, a sulfated polysaccharide, or any combination thereof.

In some embodiments, the pectin or protein hydrogel comprises gelatin, a gelatin derivative, collagen, a collagen derivative, or any combination thereof.

In some embodiments, the SAP comprises a semi-synthetic SAP. In some embodiments, the semi-synthetic SAP is a CMC-g-polyacrylic acid SAP. In some embodiments, the carboxymethyl cellulose (CMC) grafted polyacrylic acid SAP comprises 6% CMC relative to the acrylic monomers (Acrylamide-acrylic), 6% CMC relative to acrylic acid, 25% CMC relative to acrylic acid, or CMC 50% AA. In some embodiments, the CMC grafted SAP comprises 5-50% CMC relative the acrylic monomers. In some embodiments, the CMC grafted SAP comprises 6-12% CMC relative the acrylic monomers.

In some embodiments, the semi-synthetic SAP is k-carrageenan cross-linked-polyacrylic acid SAP. In some embodiments, the SAP is other than alginate or a k-carrageenan cross-linked-polyacrylic acid SAP.

In some embodiments, the SAP comprises a fully synthetic SAP. In some embodiments, the fully synthetic SAP is acrylic acid or acrylic amide or any of the combinations thereof.

In some embodiments, the SAP is capable of absorbing at least about 50, 75,'80, 85, 90, 95, 100, 200, 300, 400, 500, or 1000 times its weight in water.

In some aspects of the invention, the unit the cell comprises a heat-sealable material.

In some aspects of the invention, the cell comprises sheets each having a thickness of 10-100 micrometers.

In some aspects of the invention, the agrochemical is released from the unit by mass flow. In some aspects of the invention, the agrochemical is released from the unit by diffusion.

In some aspects of the invention, the agrochemical is released from the unit within 40 days when the unit is immersed in water at room temperature. In some aspects of the invention, the agrochemical is released from the unit within 40 days when the unit is immersed in water at room temperature. In some aspects of the invention, less than 20% by weight of the agrochemical is released from the unit within 40 days when the unit is immersed in water at room temperature. In some aspects of the invention, less than 50% by weight of the agrochemical is released from the unit within 60 days when the unit is immersed in water at room temperature.

In some the embodiments of this invention, each parameter of the wick can be adjusted to accomplish, a desired release profile. For example, each of the length, width, material, density and number of wicks can be adjusted to accomplish a desired release profile of the one or more agrochemical.

In other embodiments of the invention, the formulation of the content of the impermeable cell may be adjusted to accomplish a desired release profile of the one or more agrochemical. The content of the impermeable cell can contain inactive agents as needed to arrive at a desired release profile.

In some aspects of the invention, the release profile of the one or more agrochemicals is not affected by the formulation of the content of the cell. In some aspects of the invention, the release profile of the one or more agrochemical is not affected by the amount of the one or more agrochemical inside the cell. In some aspects of the invention, the release profile of the one or more agrochemicals is controlled only by the parameter of the wick.

In some embodiments, the agrochemical is substantially not released until after about 10, 15, 20, 25, or 30 days following application to planting soil. In some embodiments, the agrochemical is released from the unit over a period of at least about 1, 2, 3, 4, 5, 6, 7, 8, 9, 10, or 20 weeks following application to planting soil.

In some embodiments, the agrochemical is released over a period of 1 month to 8 months. In specific embodiments, the agrochemical is released over a period a growing season of a crop.

In some embodiments, the unit comprises multiple impermeable cells, arranged such that the agrochemical from a cell is released at a different time period, and/or at a different rate than the release of agrochemical from another impermeable cell of the unit. In specific embodiments, the unit is arranged so at to release a different agrochemical at a different time period during a growing season.

In some aspects of the invention, the volume of the cell is about 0.5-20 cm³. In some aspects of the invention, the volume of the cell is about 1-10 cm³. In some aspects of the invention, the volume of the cell is about 1-5 cm³ or about 2-3 cm³. In some embodiments, the volume of the cell is about 1, 2, 3, 4, 5, 6, 7, 8, 9, or 10 cm³.

In some aspects of the invention, the cell comprises 1-20, 1-10, or 1-5 g of the one agrochemical.

In some aspects of the invention, the dry weight of the unit is about 0.1 g to 20 g. In some aspects of the invention, the dry weight of the unit is about 1-10 g.

In some aspects of the invention, the unit has a capacity of about 1-10 g of the agrochemical. In some embodiments, the cell comprises at least about 0.05, 0.1, 0.2, 0.3, 0.4, 0.5, 0.6, 0.7, 0.8, 0.9, 1, 2, 5, 10 mg, or 0.05, 0.1, 0.2, 0.3, 0.4, 0.5, 0.6, 0.7, 0.8, 0.9, or 1 grams of the agrochemical. In some embodiments, the cell comprises 1 g of agrochemical. In some embodiments, the cell comprises 4 g of agrochemical. In some embodiments, the cell comprises 10 g of agrochemical.

In some aspects of the invention, the unit is in the shape of a cylinder, sphere, polyhedron, cube, or disc. In some aspects of the invention, the unit is in the shape having a cross section of a triangle, rectangle, circle, or square.

In some aspects of the invention, the agrochemical comprises fertilizer comprising nitrogen, potassium, phosphate or any of a combination thereof In some aspects of the invention, the agrochemical comprises at least one of a fertilizer, pesticide, hormone, drug, chemical growth agents, enzyme, growth promoter, biostimulant or microelement.

In some aspects of the invention, the unit further comprises gel partially or completely surrounding the unit. In some aspects of the invention, the gel comprises a hydrogel, aerogel or organogel. In some embodiments, the gel is formulated to contain one or more agrochemicals which are the same or different than the agrochemicals inside the cell of the unit.

In some aspects of the invention, the unit further comprises a root development zone partially or completely surrounding the unit. For example, WO 2014/140918 A2 and US 2014/0259906 A1, both published Sep. 18, 2014, and which are incorporated by reference herein in their entireties, disclose in some aspects a unit comprising a core or agrochemical zone and a root development zone. In some aspects of the invention, the root development zone comprises a hydrogel, aerogel, or organogel.

In some aspects of the invention, there is provided an agrochemical delivery method comprising distributing a multitude of agrochemical delivery units to plant growth medium, wherein the units individually comprise:
a) a water impermeable cell;
b) an agrochemical within the cell;
c) a wick located partially within and partially outside the cell; and wherein the unit provides extended controlled delivery of the agrochemical from the cell via the wick.

In some aspects of the invention, the method comprises distributing a multitude of agrochemical delivery units to plant growth medium. In some aspects of the invention, the units are added to the plant growth medium at one or more depths below the medium surface. In some aspects of the invention, the units are added at a depth of 1-50 cm. In some aspects of the invention, the units are added to the growth medium in a concentration of about 1 to 50, 5-50, or 10-30 units per square meter.

In some embodiments, the medium in which the plant is grown comprises soil. In some embodiments, the medium in which the plant is grown is soil. In some embodiments, the soil comprises sand, silt, clay, or any combination thereof. In some embodiments, the soil is clay, loam, clay-loam, or silt-loam. In some embodiments, the soil is artificial soil. In some embodiments, the soil is natural soil.

In some embodiments, the at least one unit is added to the soil at one or more depths below the soil surface. In some embodiments, the at least one unit is added at a depth of 1-50 cm. In some embodiments, the at least one unit is added at a depth of 1 cm, 5 cm, 10 cm, 15 cm, 20 cm, 25 cm, 30 cm, 35 cm, 40 cm, 45 cm, or 50 cm, or any combination of 2, 3, or 4 of the foregoing depths.

This invention also provides an agrochemical delivery unit comprising:
a) a cell comprising two or more cell wall segments wherein at least one segment is impermeable to water and at least one segment is permeable to water; and
b) an agrochemical within the cell.

In an embodiment, the agrochemical delivery unit comprises:
a) a cell comprising two or more cell wall segments wherein at least one segment is impermeable to water and at least one segment is permeable to water; and
b) an agrochemical within the cell;
arranged so as to permit controlled release of the agrochemical through the at least one permeable segment of the cell from inside the cell to media outside of the cell.

This invention provides an agrochemical delivery unit comprising:
a) an impermeable cell which is a cell made of material that is impermeable to water;
b) an agrochemical within the impermeable cell; and
c) a segment of the cell comprising a hydrogel.

In an embodiment, the agrochemical delivery unit comprises:
a) an impermeable cell;
b) an agrochemical within the impermeable cell; and
c) a segment of the cell having a portion located within the impermeable cell in contact with the agrochemical, and a portion located outside the impermeable cell for contact with media outside of the impermeable cell;
arranged so as to permit controlled release of the agrochemical through the segment from inside the impermeable cell to media outside of the impermeable cell.

In some embodiments, the permeable segment is a barrier. In some embodiments, the permeable segment is a conduit. In some embodiments, the permeable segment is a conductive. In some embodiment, the barrier controls the release rate of the agrochemical from the cell to the surrounding area. In some embodiments, the conduit controls the release rate of the agrochemical from the cell to the surrounding area. In some embodiments, the conductive controls the release rate of the agrochemical from the cell to the surrounding area.

In some embodiments, the barrier comprises hydrogel. In some embodiments, the conduit comprises hydrogel. In some embodiments, the conductive comprises hydrogel.

In some embodiments, the conduit comprises at least one wick. In some embodiment, the conduit comprises at least one wick and hydrogel. In one embodiment, the conduit comprises hydrogel integrated into the wick. In some embodiments, the conduit comprises at least one capillary. In one embodiment, the conduit comprises at least one capillary and hydrogel. In one embodiment, the conduit comprises porous media. In one embodiment, the porous media is silica. In one embodiment, the porous material is ceramic plate. In one embodiment, the conduit comprises hydrogel integrated into the silica. In one embodiment, the conduit comprises hydrogel integrated into the ceramic plate.

In some embodiments, the ceramic plate has a pore size of 6 μm. In some embodiment, the capillary is perforated. In some embodiments, the capillary is filled with 60 μm in diameter of grained quartz.

In some embodiments, the barrier comprises at least one wick and hydrogel. In some embodiments, the barrier comprises gel and porous media. In some embodiments, the barrier is a tube.

In some aspects, the agrochemical is released from the cell only through the permeable segment of the cell.

In some aspects of the invention, the unit comprises two or more cells. In some embodiments, the unit comprises 2-5 cells. In some embodiments, the unit comprises 2, 3, 4, 5, 6, 7, 8, 9, 10 or more than 10 cells.

In some aspects of the invention, the unit comprises two or more agrochemicals.

In some embodiments, the agrochemical is a fertilizer compound. In some embodiments, the units comprise one fertilizer compound. In some embodiments, the units comprise two fertilizer compounds. In some embodiments, the units comprise three fertilizer compounds. In some embodiments, the units comprise more than three fertilizer compounds.

In some embodiments, the fertilizer compound comprises nitrogen, potassium, phosphate or any of a combination thereof.

In some embodiments, the units comprise one to three fertilizer compounds, such that the total N, P, and/or K content as (NH₄)₂SO₂, NH₄H₂PO₄, and KCl in the medium as part of the units is about 5-50, 1-10, and 5-150 g/m2, respectively.

In some embodiments, the units comprise three fertilizer compounds, such that the total N, P, and K content as (NH₄)₂SO₂, NH₄H₂PO₄, and KCl in the medium as part of the units is about 25, 5, and 30 g/m2, respectively.

In some embodiments, the fertilizer compound is a synthetic fertilizer.

In some embodiments, the fertilizer compound is a micronutrient such as for example boron, iron, cobalt, chromium, copper, iodine, manganese, selenium, zinc or molybdenum.

In some embodiments, the fertilizer compound is PO₄, NO₃, (NH₄)₂SO₂, NH₄H₂PO₄, and/or KCl.

In some embodiments, the fertilizer compound comprises multiple fertilizer compounds which include PO₄, NO₃, (NH₄)₂SO₂, NH₄H₂PO₄, and/or KCl.

In some embodiments each of the two or more separate cells, independently, contains a different agrochemical or a different combination of agrochemicals.

In a specific embodiment, the unit is arranged so as to permit controlled release of the agrochemical through the at least one permeable segment of the cell from inside the cell to media outside of the cell.

In another embodiment, the agrochemical is dry prior to use, or prior to use of the unit the agrochemical is a paste containing water, a solution, a concentrated solution, a saturated solution, or a dispersion.

In some aspects of the invention, the cell has one impermeable segment. In some aspects of the invention, the cell has 2-25 impermeable segments. In some aspects of the invention, the cell has more than 5 impermeable segments.

In some aspects of the invention, less than 2% of the cell wall is permeable. In some aspects of the invention, less than 5% of the cell wall is permeable. In some aspects of the invention, less than 10% of the cell wall is permeable. In some aspects of the invention, less than 25% of the cell wall is permeable. In some aspects of the invention, 25% or more of the cell wall is permeable.

In some aspects of the invention, the permeable segment of the cell comprises porous material. In some aspects of the invention, the porous material is micro-porous material. In some aspects of the invention, the porous material is macro-porous material.

In some aspects of the invention, the permeable segment comprises hydrogel.

In some aspects of the invention, the hydrogel comprises a super absorbent polymer (SAP). In some aspects of the invention, the SAP comprises a natural super absorbent polymer (SAP), a poly-sugar SAP, a semi-synthetic SAP, a fully synthetic SAP, or any combination thereof. In some aspects of the invention, the unit the hydrogel comprises a synthetic hydrogel, a natural carbohydrate hydrogel, or a pectin or protein hydrogel, or any combination thereof. In some aspects of the invention, the hydrogel comprises acrylamide, an acrylic derivative, or any combination thereof.

In some embodiments, the natural carbohydrate hydrogel comprises agar, cellulose, chitosan, starch, hyaluronic acid, a dextrine, a natural gum, a sulfated polysaccharide, or any combination thereof.

In some embodiments, the pectin or protein hydrogel comprises gelatin, a gelatin derivative, collagen, a collagen derivative, or any combination thereof.

In one embodiment, the hydrogel comprises acrylic acid and carboxymethyl cellulose.

In some embodiments, the SAP comprises a semi-synthetic SAP. In some embodiments, the semi-synthetic SAP is a CMC-g-polyacrylic acid SAP. In some embodiments, the carboxymethyl cellulose (CMC) grafted polyacrylic acid SAP comprises 6% CMC relative to the acrylic monomers (Acrylamide-acrylic), 6% CMC relative to acrylic acid, 25% CMC relative to acrylic acid, or CMC 50% AA. In some embodiments, the CMC grafted SAP comprises 5-50% CMC relative the acrylic monomers. In some embodiments, the CMC grafted SAP comprises 6-12% CMC relative the acrylic monomers.

In some embodiments, the semi-synthetic SAP is k-carrageenan cross-linked-polyacrylic acid SAP. In some embodiments, the SAP is other than alginate or a k-carrageenan cross-linked-polyacrylic acid SAP.

In some embodiments, the SAP comprises a fully synthetic SAP. In some embodiments, the fully synthetic SAP is acrylic acid or acrylic amide or any of the combinations thereof.

In some embodiments, the SAP is capable of absorbing at least about 50, 75, 80, 85, 90, 95, 100, 200, 300, 400, 500, or 1000 times its weight in water.

In some aspects of the invention, the cell comprises one or more of polyethylene, polypropylene, or polyester. In some embodiments, the cell comprises polypropylene. In some aspects of the invention, the cell comprises one or more of a polylactic acid, a polyhydroxyalkanoate, a polyhydroxybutyrate, or a polyhydroxyvalerate. In some embodiments, the cell comprises polylactic acid. In some aspects of the invention, the cell comprises a thermoplastic starch, cellulose acetate, or other cellulose-based material. In some aspects of the invention, the cell comprises polycaprolactone, polyglycolide, polydioxanone, or any combinations or copolymers thereof.

In some aspects of the invention, the agrochemical is released from the unit by mass flow. In some aspects of the invention, the agrochemical is released from the unit by diffusion. In some aspects of the invention, the agrochemical is released from the unit within 40 days when the unit is immersed in water at room temperature. In some aspects of the invention, the agrochemical is released from the unit within 40 days when the unit is immersed in water at room temperature. In some aspects of the invention, less than 20% by weight of the agrochemical is released from the unit within 40 days when the unit is immersed in water at room temperature. In some aspects of the invention, less than 50% by weight of the agrochemical is released from the unit within 60 days when the unit is immersed in water at room temperature.

In some embodiments, the agrochemical is substantially not released until after about 10, 15, 20, 25, or 30 days following application to planting soil. In some embodiments, the agrochemical is released from the unit over a period of at least about 1, 2, 3, 4, 5, 6, 7, 8, 9, 10, or 20 weeks following application to planting soil.

In some embodiments, the agrochemical is released over a period of 1 month to 8 months. In specific embodiments, the agrochemical is released over a period a growing season of a crop. In some embodiments, the agrochemical is released over a period of 8-12 months. In some embodiments, the agrochemical is released over a period of more than 12 months.

In some embodiments, the unit comprises multiple cells, arranged such that the agrochemical from a cell is released at a different time period, and/or at a different rate than the release of agrochemical from another cell of the unit. In specific embodiments, the unit is arranged so at to release a different agrochemical at a different release rate during a growing season.

In some aspects of the invention, each parameter of the cell can be adjusted to accomplish a desired release profile.

In some aspects of the invention, the formulation of the content of the cell may be adjusted to accomplish a desired release profile of the one or more agrochemical. The content of the cell can contain inactive agents as needed to arrive at a desired release profile.

In some aspects of the invention, each parameter of the at least one permeable segment can be adjusted to accomplish a desired release profile. In some aspects of the invention, the parameter is the number of permeable segments. In some aspects of the invention, the parameter is the percentage of permeable segments in the cell wall. In some aspects of the invention, the parameter is the dimension of the permeable segment. In some aspects of the invention, the parameter is the composition of the permeable segment.

In some aspects of the invention, the release profile of the one or more agrochemicals is not affected by the formulation of the content of the cell. In some aspects of the invention, the release profile of the one or more agrochemical is not affected by the amount of the one or more agrochemical inside the cell. In some aspects of the invention, the release profile of the one or more agrochemicals is controlled only by the parameter of the at least one permeable segment.

In some embodiments, the permeable segment is at least 0.002% of the complete cell wall. In some embodiments, the permeable segment is between 0.002% to 5% of the complete cell wall. In some embodiments, the permeable segment is only hydrogel. In some embodiments, the permeable segment is only hydrogel and the release rate is 1×10⁻⁵-1×10⁻³ (g×d⁻¹).

In some embodiments, the permeable segment is oriented porous media comprising hydrogel and the release rate is 1×10⁻⁵-1×10⁻³ (g×d⁻¹). In some embodiments, the oriented porous media is wick.

In some embodiments, the permeable segment is non-oriented porous media comprising hydrogel and the release rate is 1×10⁻⁶-1×10⁻⁴ (g×d⁻¹). In some embodiments, the non-oriented porous media is silica or ceramic plate.

In some embodiments, the release rate of the at least one agrochemical is 1×10⁻⁸-1×10⁻¹ (g×d⁻¹). In some embodiments, the release rate of the at least one agrochemical is 1×10⁻³-4×10⁻¹ (g×d⁻¹). In some embodiments, the release rate of the at least one agrochemical is 1.7×10⁻³-2.0×10⁻³ (g×d⁻¹). In some embodiments, the release rate of the at least one agrochemical is 1.0×10⁻³-2.9×10⁻³ (g×d⁻¹). In some embodiments, the release rate of the at least one agrochemical is 1.7×10⁻³-2.7×10⁻³ (g×d⁻¹). In some embodiments, the release rate of the at least one agrochemical is 2.2×10⁻³-3.1×10⁻¹ (g×d⁻¹).

In some embodiments, the at least one agrochemical is a fertilizer. In some embodiments, the release rate of the fertilizer is 1×10⁻⁴-1×10⁻¹(g×d⁻¹). In some embodiments, the at least one agrochemical is a plant protection product or plant growth enhancer. In some embodiments, the release rate of the plant protection product or plant growth enhancer is 1×10⁻⁸-1×10⁻² (g×d⁻¹). In some embodiments, the length of the permeable segment is at least 1 mm. In some embodiments, the length of the permeable segment is about 1 mm to 20 mm. In some embodiments, the diameter of the permeable segment is at least 0.01 mm. In some embodiments, the diameter of the permeable segment is about 0.01 mm to 2 mm.

In some aspects of the invention, the volume of the cell is about 0.5-20 cm³. In some aspects of the invention, the volume of the cell is about 1-10 cm³. In some aspects of the invention, the volume of the cell is about 1-5 cm³ or about 2-3 cm³. In some embodiments, the volume of the cell is about 1, 2, 3, 4, 5, 6, 7, 8, 9, or 10 cm³.

In some aspects of the invention, the cell comprises 1-20, 1-10, or 1-5 g of the one agrochemical.

In some aspects of the invention, the cell comprises 1 g of the one agrochemical. In some aspects of the invention, the cell comprises 4 g of the one agrochemical. In some aspects of the invention, the dry weight of the unit is about 0.1 g to 20 g. In some aspects of the invention, the dry weight of the unit is about 1-10 g.

In some aspects of the invention, the unit has a capacity of about 1-10 g of the agrochemical. In some embodiments, the cell comprises at least about 0.05, 0.1, 0.2, 0.3, 0.4, 0.5, 0.6, 0.7, 0.8, 0.9, 1, 2, 5, 10 mg, or 0.05, 0.1, 0.2, 0.3, 0.4, 0.5, 0.6, 0.7, 0.8, 0.9, or 1 grams of the agrochemical. In some aspects of the invention, the unit is in the shape of a cylinder, sphere, polyhedron, cube, or disc. In some aspects of the invention, the unit is in the shape having a cross section of a triangle, rectangle, circle, or square.

In some aspects of the invention, the agrochemical comprises fertilizer comprising nitrogen, potassium, phosphate or any of a combination thereof. In some aspects of the invention, the agrochemical comprises at least one of a fertilizer, pesticide, hormone, drug, chemical growth agents, enzyme, growth promoter, biostimulant or microelement.

In some aspects of the invention, the unit further comprises gel partially or completely surrounding the unit. In some aspects of the invention, the gel comprises a hydrogel, aerogel or organogel. In some embodiments, the gel is formulated to contain one or more agrochemicals which are the same or different than the agrochemicals inside the cell of the unit.

In some aspects, the invention provides an agrochemical delivery method comprising distributing a multitude of agrochemical delivery units to plant growth medium, wherein the units individually comprise:
a) a cell comprising two or more cell wall segments wherein at least one segment is impermeable to water and at least one segment is permeable to water; and
b) an agrochemical within the cell;

wherein the unit provides extended controlled delivery of the agrochemical from the cell via the at least one permeable segment of the cell.

In some aspects, the invention provides an agrochemical delivery method comprising distributing a multitude of agrochemical delivery units to plant growth medium, wherein the units individually comprise:
a) a water impermeable cell;
b) an agrochemical within the cell;
c) a segment of the cell located partially within and partially outside the cell; and wherein the unit provides extended controlled delivery of the agrochemical from the cell via the segment.

In some aspects of the invention, the method comprises distributing a multitude of agrochemical delivery units to plant growth medium. In some aspects of the invention, the units are added to the plant growth medium at one or more depths below the medium surface. In some aspects of the invention, the units are added at a depth of 1-50 cm. In some aspects of the invention, the units are added to the growth medium in a concentration of about 1 to 50, 5-50, or 10-30 units per square meter.

In some embodiments, the medium in which the plant is grown comprises soil. In some embodiments, the medium in which the plant is grown is soil. In some embodiments, the soil comprises sand, silt, clay, or any combination thereof. In some embodiments, the soil is clay, loam, clay-loam, or silt-loam. In some embodiments, the soil is artificial soil. In some embodiments, the soil is natural soil.

In some embodiments, the at least one unit is added to the soil at one or more depths below the soil surface. In some embodiments, the at least one unit is added at a depth of 1-50 cm. In some embodiments, the at least one unit is added at a depth of 1 cm, 5 cm, 10 cm, 15 cm, 20 cm, 25 cm, 30 cm, 35 cm, 40 cm, 45 cm, or 50 cm, or any combination of 2, 3, or 4 of the foregoing depths.

In some aspects, the present invention provides a process of making an agrochemical delivery unit comprising: creating a cell comprising two or more cell wall segments wherein at least one segment is impermeable to water and at least one segment is permeable to water and encapsulating an agrochemical into the cell such that the at least one agrochemical is released through the at least one permeable segment of the cell in a controlled manner after it is in contact with water.

In some embodiments, the invention provides a method of reducing environmental damage caused by an agrochemical, comprising delivering the agrochemical to the root of a plant by adding at least one unit of the invention to the medium of the plant.

In some embodiments, the present invention provides a method of minimizing exposure to an agrochemical, comprising delivering the agrochemical to the root of a plant by adding at least one unit of the invention to the medium of the plant.

In some embodiments, the present invention provides a method of delivering an agrochemical to create a zone for preferential root development of a plant, comprising:
i) adding one or more units of the invention to the root zone of the plant; or
ii) adding one or more units of the invention to the anticipated root zone of the medium in which the plant is anticipated to grow.

In some embodiments, the plant is grown in a field. In some embodiments, the plant is a crop plant. In some embodiments, the crop plant is a grain or a tree crop plant. In some embodiments, the crop plant is a fruit or a vegetable plant.

In some embodiments, the plant is a banana, barley, bean, cassava, corn, cotton, grape, orange, pea, potato, rice, soybean, sugar beet, tomato, or wheat plant. In some embodiments, the plant is a sunflower, cabbage plant, lettuce, or celery plant. In some embodiments, the plant is grown at home (plant pot) and garden. In some embodiments, the plant is a crop plant. In some embodiments, the crop plant is an ornamental plant, a grain or a tree crop plant. In some embodiments, the crop plant is a fruit or a vegetable plant

The present invention provides a method of increasing the yield of a plant, comprising (i) adding one or more units of the invention to a medium where the plant is growing or is to be grown, and (ii) growing the plant, wherein the yield of the plant is higher when grown in the medium containing the units than in the medium not containing the units.

The present invention provides a method of increasing the growth rate of a plant, comprising (i) adding one or more units of the invention to a medium where the plant is growing or is to be grown, and (ii) growing the plant, wherein the plant grows faster in the medium containing the units than in the medium not containing the units.

The present invention provides a method of increasing the size of a plant, comprising (i) adding one or more units of the invention to a medium where the plant is growing or is to be grown, and (ii) growing the plant, wherein the plant grows larger in the medium containing the units than in the medium not containing the units.

The present invention provides a method of increasing N, P, and/or K uptake by a plant, comprising (i) adding one or more units of the invention to a medium where the plant is growing or is to be grown, and (ii) growing the plant, wherein the N, P, and/or K uptake of the plant is greater in the medium containing the units than in the medium not containing the units.

The present invention provides a method of efficient controlled release of agrochemical at low ambient temperatures, comprising (i) adding one or more units of the invention to a medium where the plant is growing or is to be grown, and (ii) growing the plant, wherein the influence of low ambient temperature on the release rates is reduced.

In some embodiments, low ambient temperature is below 15° C., below 12° C., below 10° C., below 8° C., below 6° C., below 4° C., below 2° C., or below 0° C.

The present invention provides a method of efficient controlled release of agrochemical at high ambient temperatures, comprising (i) adding one or more units of the invention to a medium where the plant is growing or is to be grown, and (ii) growing the plant, wherein the influence of high ambient temperature on the release rates is reduced.

In some embodiments, high ambient temperature is above 23° C., above 25° C., above 30° C., or above 40° C.

The present invention provides a method of efficient controlled release of agrochemical at low ambient moisture, comprising (i) adding one or more units of the invention to a medium where the plant is growing or is to be grown, and (ii) growing the plant, wherein the influence of low ambient moisture on the release rates is reduced.

In some embodiments, the crop plant is a wheat plant, a maize plant, a soybean plant, a rice plant, a barley plant, a cotton plant, a pea plant, a potato plant, a tree crop plant, or a vegetable plant.

In some embodiments, the present invention provides a method of growing a plant, comprising adding at least one unit of the invention to the medium in which the plant is grown.

In some embodiments, the units are added to the growth medium in a concentration of about 1 to 50, 5-50, 10-30 units per square meter.

In some aspects of the invention, there is provided a method of making an agrochemical delivery unit comprising: creating a cell by encapsulating at least one agrochemical into a non-permeable polymeric cell equipped with a wick positioned party within and partly outside the cell such that the at least one agrochemical is released through the wick in a controlled manner after it is in contact with water.

In some aspects of the invention, there is provided a method of making an agrochemical delivery unit comprising: (i) creating a cell comprising two or more cell wall segments wherein at least one segment is impermeable to water and at least one segment is permeable to water, and (ii) encapsulating at least one agrochemical into the cell such that the at least one agrochemical is released through the at least one permeable segment in a controlled manner after it is in contact with water.

In some aspects of the invention, the encapsulation comprises using an extruder that attaches a polymeric layer surrounding the at least one agrochemical. In some aspects of the invention, the encapsulation comprises filling the agrochemical into a polymeric cell and sealing the cell together with a wick. In some aspects of the invention, a hydrogel is polymerized around the cell. In some aspects of the invention, the encapsulating comprises a first polymerization step and a second polymerization step.

In another embodiment, the agrochemical delivery unit is made by a process comprising generating the cell by stretching the polymer sheet using vacuum, loading the fertilizer into the cell, then, optionally in parallel, placing wicks on top of notched polymer sheet, welding a second polymer sheet on top of the notch and wicks, and welding the covered notched sheet with wicks on top of cell. In some embodiments, the notched polymer sheet is welded to the cell using heat pulse.

Unless otherwise defined, all technical and scientific terms used herein have the same meaning as commonly understood by a person of ordinary skill in the art to which this invention belongs.

As used herein, and unless stated otherwise or required otherwise by context, each of the following terms shall have the definition set forth below.

It is understood that where a parameter range is provided, all integers within that range, and tenths thereof, are also provided by the invention. For example, “0.2-5 mg/kg/day” is a disclosure of 0.2 mg/kg/day, 0.3 mg/kg/day, 0.4 mg/kg/day, 0.5 mg/kg/day, 0.6 mg/kg/day etc. up to 5.0 mg/kg/day.

As used herein, “about” in the context of a numerical value or range means +10% of the numerical value or range recited or claimed, unless the context requires a more limited range.

As used herein, the term “impermeable” when used to describe a cell wall segment means that the cell wall segment does not allow a substantial amount of fluid to pass through. Fluid includes, but is not limited to, water.

As used herein, the term “permeable” when used to describe a cell wall segment means that the cell wall segment allows a substantial amount of fluid to pass through. Fluid includes, but is not limited to, water.

As used herein, the term “permeable segment” refers to barrier and/or conduit and/or conductive which controls the release rate of the chemical from the cell to the surrounding area.

The term “controlled release” when used to refer to a unit described herein means that the unit is arranged to release one or more agrochemicals of the impermeable cell gradually over time. In some embodiments, the unit is arranged to release an agrochemical into medium surrounding the cell, for example, the root development zones, over a period of at least about one week when the root development zones are swelled. In some embodiments, the unit is arranged so as to release the agrochemical over a period of 4 weeks, 3 months, or up to 8 months, and most preferably over the period of time of a growing season of a crop. “Controlled release” is interchangeable with the term “slow release” (“SR”).

“DAP” means days after planting.

Unless required otherwise by context, a “unit” refers to a unit for delivery of agrochemicals to the roots of a plant as described herein. A “fertilizer unit” refers to a unit for delivery of agrochemicals to the roots of a plant as described herein which comprises a fertilizer. A “fertilizer/pesticide unit” refers to a unit for delivery of agrochemicals to the roots of a plant as described herein which comprises a fertilizer and a pesticide.

As used herein, a “wick” is a component of the agrochemical delivery unit described herein that has a length greater than its cross-section. A “wick” can be made of any suitable material, including fiber mesh, cotton or other cellulose fiber, ceramic, or glass-based fiber, porous material possessing capillary structure, a micro-porous material, a macro-porous material.

As used herein, a “permeable segment” is a component of the agrochemical delivery unit described herein that has cross-section greater than its length.

A “root development zone” is a component of a unit of the invention which, when hydrated, can be penetrated by a growing root. In some embodiments, the growing root can grow and develop within the root development zone of a unit. In some embodiments, a root development zone is a super absorbent polymer (SAP). In some embodiments, the root development zone is an aerogel, a geotextile, or a sponge. In some embodiments, the root development zone will take up water from the surrounding environment when, for example, the unit is placed in soil (artificial or natural) which is subsequently irrigated. In some embodiments, the hydrated root development zones create an artificial environment in which a growing root can uptake water and nutrients. In some embodiments, the root development zones of a unit are formulated to contain one or more agrochemicals which are the same or different than the agrochemicals of the agrochemical zones of the unit. While the invention described herein is not limited to any particular mechanism of action, it is believed that a growing root is attracted to the root development zones of a unit because of the presence of water and/or agrochemicals (e.g. minerals) in the root development zones. It is believed that roots can continue to grow and develop within the root development zones of units because of the continued availability of water and/or agrochemicals in the units.

Plants provided by or contemplated for use in embodiments of the present invention include both monocotyledons and dicotyledons. In some embodiments, a plant is a crop plant. As used herein, a “crop plant” is a plant which is grown commercially. In some embodiments, the plants of the present invention are crop plants (for example, cereals and pulses, maize, wheat, potatoes, tapioca, rice, sorghum, millet, cassava, barley, or pea), or other legumes. In some embodiments, the crop plants may be grown for production of edible roots, tubers, leaves, stems, flowers or fruit. The plants may be vegetable or ornamental plants. Non-limiting examples of crop plants of the invention include: Acrocomia aculeata (macauba palm), Arabidopsis thaliana, Aracinis hypogaea (peanut), Astrocaryum murumuru (murumuru), Astrocaryum vulgare (tucumã), Attalea geraensis (Indaiá-rateiro), Attalea humilis (American oil palm), Attalea oleifera (andaiá), Attalea phalerata (uricuri), Attalea speciosa (babassu), Avena sativa (oats), Beta vulgaris (sugar beet), Brassica sp. such as Brassica carinata, Brassica juncea, Brassica napobrassica, Brassica napus (canola), Camelina sativa (false flax), Cannabis sativa (hemp), Carthamus tinctorius (safflower), Caryocar brasiliense (pequi), Cocos nucifera (Coconut), Crambe abyssinica (Abyssinian kale), Cucumis melo (melon), Elaeis guineensis (African palm), Glycine max (soybean), Gossypium hirsutum (cotton), Helianthus sp. such as Helianthus annuus (sunflower), Hordeum vulgare (barley), Jatropha curcas (physic nut), Joannesia princeps (arara nut-tree), Lemna sp. (duckweed) such as Lemna aequinoctialis, Lemna disperma, Lemna ecuadoriensis, Lemna gibba (swollen duckweed), Lemna japonica, Lemna minor, Lemna minuta, Lemna obscura, Lemna paucicostata, Lemna perpusilla, Lemna tenera, Lemna trisulca, Lemna turionifera, Lemna valdiviana, Lemna yungensis, Licania rigida (oiticica), Linum usitatissimum (flax), Lupinus angustifolius (lupin), Mauritia flexuosa (buriti palm), Maximiliana maripa (inaja palm), Miscanthus sp. such as Miscanthus x giganteus and Miscanthus sinensis, Nicotiana sp. (tabacco) such as Nicotiana tabacum or Nicotiana benthamiana, Oenocarpus bacaba (bacaba-do-azeite), Oenocarpus bataua (patauã), Oenocarpus distichus (bacaba-de-leque), Oryza sp. (rice) such as Oryza sativa and Oryza glaberrima, Panicum virgatum (switchgrass), Paraqueiba paraensis (mari), Persea amencana (avocado), Pongamia pinnata (Indian beech), Populus trichocarpa, Ricinus communis (castor), Saccharum sp. (sugarcane), Sesamum indicum (sesame), Solanum tuberosum (potato), Sorghum sp. such as Sorghum bicolor, Sorghum vulgare, Theobroma grandiforum (cupuassu), Trifolium sp., Trithrinax brasiliensis (Brazilian needle palm), Triticum sp. (wheat) such as Triticum aestivum, Zea mays (corn), alfalfa (Medicago sativa), rye (Secale cerale), sweet potato (Lopmoea batatus), cassava (Manihot esculenta), coffee (Cofea spp.), pineapple (Anana comosus), citris tree (Citrus spp.), cocoa (Theobroma cacao), tea (Camellia senensis), banana (Musa spp.), avocado (Persea americana), fig (Ficus casica), guava (Psidium guajava), mango (Mangifer indica), olive (Olea europaea), papaya (Carica papaya), cashew (Anacardium occidentale), macadamia (Macadamia intergrifolia) and almond (Prunus amygdalus).

Unless stated otherwise or required otherwise by context, “swelled” means that a material has an absorbed amount of water which is at least about 1% of the amount of water that would be absorbed by the material if placed in deionized water for 24 hours at 21° C. When the material is a hydrogel, a “swelled” hydrogel can be referred to as a “hydrated” hydrogel. In some embodiments, a swelled material has an absorbed amount of water which is at least about 2% of the amount of water that would be absorbed by the material if placed in deionized water for 24 hours at 21° C. In some embodiments, a swelled material has an absorbed amount of water which is at least about 3% of the amount of water that would be absorbed by the material if placed in deionized water for 24 hours at 21° C. In some embodiments, a swelled material has an absorbed amount of water which is at least about 4% of the amount of water that would be absorbed by the material if placed in deionized water for 24 hours at 21° C. In some embodiments, a swelled material has an absorbed amount of water which is at least about 5% of the amount of water that would be absorbed by the material if placed in deionized water for 24 hours at 21° C.

Unless stated otherwise or required otherwise by context, “hydrated” means at least about 1% hydrated. In some embodiments, “hydrated” means at least about 2% hydrated. In some embodiments, “hydrated” means at least about 3% hydrated. In some embodiments, “hydrated” means at least about 4% hydrated. In some embodiments, “hydrated” means at least about 5% hydrated.

As used herein, a “fully swelled” unit of the invention is a unit which contains an amount of absorbed water which is equal to the amount of water the unit would absorb if placed in deionized water for 24 hours at 21° C.

As used herein, an artificial environment means a media located within the root zone of an agricultural field or a garden plant loaded with an agrochemical, encourages root growth and uptake activity within its internal periphery. Non-limiting examples of agrochemicals include pesticides, including insecticides, herbicides, and fungicides. Agrochemicals may also include natural and synthetic fertilizers, hormones and other chemical growth agents.

The unit may contain the input (fertilizer, pesticide, or other agrochemical) in a structure that controls its release into the root development zone. The release rate is designed to meet plant demands throughout the growing season. In some embodiments, no input residuals remain at the end of a predetermined action period.

Units made with a water soluble pesticide may be formulated so that the water-soluble pesticide is contained in one or more cells together with or without other agrochemicals, e.g. fertilizers. These unit maybe arranged, or the content of the cell may be formulated, to release the pesticide into the root development zones or soil surrounding the plant in a controlled release manner.

Units made with hydrophobic pesticides may arranged, or the content of the cell may be formulated so that the hydrophobic pesticide is contained together with or without other agrochemicals, e.g. fertilizers. These unit do not need to be have any additional controlled release mechanism, e.g. a coating system, because the hydrophobic nature of the pesticide will limit its rate of release, including its release into the root development zones. Thus, the hydrophobic nature of the pesticide will limit the rate at which the pesticide leaches from the unit into the surrounding medium. Thus, in some instances, it will be economically advantageous to formulate hydrophobic pesticides in one or more cell lacking a controlled release mechanism, and/or to disperse the pesticide throughout one or more root development zones.

In some embodiments, the cell comprises one or more fertilizers, pesticides, and/or other agrochemicals such as nitrogen, phosphorus, potassium, etc., in a beehive like structure made from highly cross linked polymer coated with silica or highly cross linked poly acrylic acid/poly sugar with a clay filler. In some embodiments, the cell comprises fertilizer, pesticide, and/or at least one other agrochemical in a beehive like structure with or without an external coating.

Root development zones of the present invention are sustainable in soils, and encourage root penetration, uptake activity, and growth and/or development in the root development zone. In some embodiments, a super absorbent polymer may serve as the root development zone since during watering it can absorb soil moisture, swell and maintain its high water content over long period of time. These features establish a zone where gradual transition of chemical concentration exists between the cell and the periphery of the root development zone allowing root uptake activity during the unit of the invention's life cycle. In some embodiments, the root development zone has features such as mechanical resistance (in order to maintain its shape and geometry in the soil);

swelling cycle capability (capable of repeated hydration and dehydration in response to soil water content); oxygen permeability—(maintaining sufficient oxygen level to support root activity, such as root development); and root penetration (allowing the growth of roots into it).

Materials that may be used in the present invention include but are not limited to: 1) clay 2) zeolite 3) tuff 4) fly ash 5) hydrogel 6) foam.

In some embodiments, an artificial environment of the present invention serves as a buffer for soil type and pH to provide universal root growth environment. In some embodiments, an artificial environment of the present invention contains needed materials and nutrients in the desired conditions, such as but not limited to water, fertilizers, drugs, and other additives.

Super Absorbent Polymers

Super Absorbent Polymers are polymers that can absorb and retain extremely large amounts of a liquid relative to their own mass. Non-limiting examples of SAPs that are useful in embodiments of the subject invention are described in K. Horie, M. Baron, R. B. Fox, J. He, M. Hess, J. Kahovec, T. Kitayama, P. Kubisa, E. Maréchal, W. Mormann, R. F. T. Stepto, D. Tabak, J. Vohlídal, E. S. Wilks, and W. J. Work (2004). “Definitions of terms relating to reactions of polymers and to functional polymeric materials (IUPAC Recommendations 2003)”. Pure and Applied Chemistry 76 (4): 889-906; Kabiri, K. (2003). “Synthesis of fast-swelling superabsorbent hydrogels: effect of crosslinker type and concentration on porosity and absorption rate”. European Polymer Journal 39 (7): 1341-1348; “History of Super Absorbent Polymer Chemistry”. M2 Polymer Technologies, Inc. (available from www.m2polymer.com/html/history_of_superabsorbents.html); “Basics of Super Absorbent Polymer & Acrylic Acid Chemistry”. M2 Polymer Technologies, Inc. (available from www.m2polymer.com/html/chemistry_sap.html); Katime Trabanca, Daniel; Katime Trabanca, Oscar; Katime Amashta, Issa Antonio (September 2004). Los materiales inteligentes de este milenio: Los hidrogeles macromoleculares. Síntesis, propiedades y aplicaciones. (1 ed.). Bilbao: Servicio Editorial de la Universidad del País Vasco (UPV/EHU); and Buchholz, Fredric L; Graham, Andrew T, ed. (1997). Modern Superabsorbent Polymer Technology (1 ed.). John Wiley & Sons, the entire contents of each of which are hereby incorporated herein by reference.

Non-limiting examples of hydrogels that are useful in embodiments of the subject invention are described in Mathur et al., 1996. “Methods for Synthesis of Hydrogel Networks: A Review” Journal of Macromolecular Science, Part C: Polymer Reviews Volume 36, Issue 2, 405-430; and Kabiri et al., 2010. “Superabsorbent hydrogel composites and nanocomposites: A review” Volume 32, Issue 2, pages 277-289, the entire contents of each of which are hereby incorporated herein by reference.

Geotextiles

Geotextiles are permeable fabrics which are typically used to prevent the movement of soil or sand when placed in contact with the ground. Non-limiting examples of geotextiles that are useful in embodiments of the subject invention are described in U.S. Pat. Nos. 3,928,696, 4,002,034, 6,315,499, 6,368,024, and 6,632,875, the entire contents of each of which are hereby incorporated herein by reference.

Aerogels

Aerogels are gels formed by the dispersion of air in a solidified matrix. Non-limiting examples of aerogels that are useful in embodiments of the subject invention are described in Aegerter, M., ed. (2011) Aerogels Handbook. Springer, the entire contents of which is hereby incorporated herein by reference.

Agrochemicals

As used herein, the term “agrochemical” means an active ingredient used in the practice of farming, including cultivation of the soil for the growing of crops. However, the use of agricultural materials is not limited to application to crops. Agricultural materials may be applied to soil surrounding any plant, e.g., for the purpose of aiding or inhibiting growth of a living organism.

Examples of agrochemicals include, but are not limited to, pesticides, hormones, bio-stimulants, and plant growth agents.

As used herein, the term “pesticide”, “pesticide compound” or “pesticidal compound” means a compound capable of killing or inhibiting growth or proliferation of a pest, whether for plant protection or for non-crop application. As used herein, all “pesticide”, “pesticide compound” or “pesticidal compound” fall within “agrochemical”. The term “pesticide”, “pesticide compound” or “pesticidal compound” includes, but is not limited to, insecticide, nematicide, herbicide, fungicide, algicides, animal repellents, and acaricides. As used herein, the term “pest” includes, but is not limited to, insect, nematode, weed, fungi, algae, mite, tick, and animal. As used herein, the term “weed” refers to any unwanted vegetation.

Fertilizers

A fertilizer is any organic or inorganic material of natural or synthetic origin (other than living materials) that is added to a plant medium to supply one or more nutrients that promotes growth of plants.

Non-limiting examples of fertilizers that are useful in embodiments of the subject invention are described in Stewart, W. M.; Dibb, D. W.; Johnston, A .E.; Smyth, T. J. (2005). “The Contribution of Commercial Fertilizer Nutrients to Food Production”. Agronomy Journal 97: 1-6.; Erisman, Jan Willem; M A Sutton, J Galloway, Z Klimont, W Winiwarter (October 2008). “How a century of ammonia synthesis changed the world”. Nature Geoscience 1 (10): 636.; G. J. Leigh (2004). The world's greatest fix: a history of nitrogen and agriculture. Oxford University Press US. pp. 134-139; Glass, Anthony (September 2003). “Nitrogen Use Efficiency of Crop Plants: Physiological Constraints upon Nitrogen Absorption”. Critical Reviews in Plant Sciences 22 (5): 453; Vance; Uhde-Stone & Allan (2003). “Phosphorus acquisition and use: critical adaptations by plants for securing a non renewable resource”. New Phythologist (Blackwell Publishing) 157 (3): 423-447.; Moore, Geoff (2001). Soilguide - A handbook for understanding and managing agricultural soils. Perth, Western Australia: Agriculture Western Australia. pp. 161-207; Häussinger, Peter; Reiner Lohmüller, Allan M. Watson (2000). Ullmann's Encyclopedia of Industrial Chemistry, Volume 18. Weinheim, Germany: Wiley-VCH Verlag GmbH & Co. KGaA. pp. 249-307.; Carroll and Salt, Steven B. and Steven D. (2004). Ecology for Gardeners. Cambridge: Timber Press.; Enwall, Karin; Laurent Philippot,2 and Sara Hallin1 (December 2005). “Activity and Composition of the Denitrifying Bacterial Community Respond Differently to Long-Term Fertilization”. Applied and Environmental Microbiology (American Society for Microbiology) 71 (2): 8335-8343.; Birkhofera, Klaus; T. Martijn Bezemerb, c, d, Jaap Bloeme, Michael Bonkowskia, Søren Christensenf, David Duboisg, Fleming Ekelundf, Andreas Flieβbachh, Lucie Gunstg, Katarina Hedlundi, Paul Mäderh, Juha Mikolaj, Christophe Robink, Heikki Setäläj, Fabienne Tatin-Frouxk, Wim H. Van der Puttenb, c and Stefan Scheua (September 2008). “Long-term organic farming fosters below and aboveground biota: Implications for soil quality, biological control and productivity”. Soil Biology and Biochemistry (Soil Biology and Biochemistry) 40 (9): 2297-2308.; Lal, R. (2004). “Soil Carbon Sequestration Impacts on Global Climate Change and Food Security”. Science (Science (journal)) 304 (5677): 1623-7.; and Zublena, J.P.; J. V. Baird, J. P. Lilly (June 1991). “SoilFacts—Nutrient Content of Fertilizer and Organic Materials”. North Carolina Cooperative Extension Service. (available from www.soil.ncsu.edu/publications/Soilfacts/AG-439-18/), the entire contents of each of which are hereby incorporated herein by reference.

Non-limiting examples of fertilizers which may be useful in embodiments of the present invention include Ammonium nitrate, Ammonium sulfate, anhydrous ammonia, calcium nitrate/urea, oxamide, potassium nitrate, urea, urea sulfate, ammoniated superphosphate, diammonium phosphate, nitric phosphate, potassium carbonate, potassium metaphosphate, calcium chloride, magnesium ammonium phosphate, magnesium sulfate, ammonium sulfate, potassium sulfate, and others disclosed herein.
Pesticides Pesticides are substances or mixtures of substances capable of preventing, destroying, repelling or mitigating any pest. Pesticides include insecticides, nematicides, herbicides and fungicides.
Insecticides

Insecticides are pesticides that are useful against insects, and include but are not limited to organochloride, organophosphate, carbamate, pyrethroid, neonicotinoid, and ryanoid insecticides.

Non-limiting examples of insecticides that are useful in embodiments of the subject invention are described in van Emden HF, Pealall DB (1996) Beyond Silent Spring, Chapman & Hall, London, 322pp; Rosemary A. Cole “Isothiocyanates, nitriles and thiocyanates as products of autolysis of glucosinolates in Cruciferae” Phytochemutry, 1976. Vol. 15, pp. 759-762; and Robert L. Metcalf “Insect Control” in Ullmann's Encyclopedia of Industrial Chemistry” Wiley-VCH, Weinheim, 2002, the entire contents of each of which are incorporated herein by reference. Exemplary insecticides include Aldicarb, Bendiocarb, Carbofuran, Ethienocarb, Fenobucarb, Oxamyl, Methomyl, Acetamiprid, Clothianidin, Dinotefuran, Imidacloprid, Nitenpyram, Nithiazine, Thiacloprid, Thiamethoxam, Mirex, Tetradifon, Phenthoate, Phorate, Pirimiphos-methyl, Quinalphos, Terbufos, Tribufos, Trichlorfon, Tralomethrin, Transfluthrin, Fenoxycarb, Fipronil, Hydramethylnon, Indoxacarb, and Limonene. Additional exemplary insecticides include Carbaryl, Propoxur, Endosulfan, Endrin, Heptachlor, Kepone, Lindane, Methoxychlor, Toxaphene, Parathion, Parathion-methyl, Phosalone, Phosmet, Phoxim, Temefos, Tebupirimfos, and Tetrachlorvinphos.
Nematicides

Nematicides are pesticides that are useful against plant-parasitic nematodes. Non-limiting examples of nematicides that are useful in embodiments of the subject invention are described in D. J. Chitwood, “Nematicides,” in Encyclopedia of Agrochemicals (3), pp. 1104-1115, John Wiley & Sons, New York, N.Y., 2003; and S. R. Gowen, “Chemical control of nematodes: efficiency and side-effects,” in Plant Nematode Problems and their Control in the Near East Region (FAO Plant Production and Protection Paper—144), 1992, the entire contents of each of which are incorporated herein by reference.
Herbicides

Herbicides are pesticides that are useful against unwanted plants. Non-limiting examples of herbicides that are useful in embodiments of the subject invention include 2,4-D, aminopyralid, atrazine, clopyralid, dicamba, glufosinate ammonium, fluazifop, fluroxypyr, imazapyr, imazamox, metolachlor, pendimethalin, picloram, triclopyr, mesotrione, and glyphosate.
Fungicides

Fungicides are pesticides that are useful against fungi and/or fungal spores. Non-limiting examples of fungicides that are useful in embodiments of the subject invention are described in Pesticide Chemistry and Bioscience edited by G. T Brooks and T. R Roberts. 1999. Published by the Royal Society of Chemistry; Metcalfe, R. J. et al. (2000) The effect of dose and mobility on the strength of selection for DMI (sterol demethylation inhibitors) fungicide resistance in inoculated field experiments. Plant Pathology 49: 546-557; and Sierotzki, Helge (2000) Mode of resistance to respiration inhibitors at the cytochrome bc1 enzyme complex of Mycosphaerella fijiensis field isolates Pest Management Science 56:833-841, the entire contents of each of which are incorporated herein by reference. Exemplary fungicides include azoxystrobin, cyazofamid, dimethirimol, fludioxonil, kresoxim-methyl, fosetyl-A1, triadimenol, tebuconazole, and flutolanil.
Microelements

Non-limiting examples of microelements that are useful in embodiments of the subject invention include iron, manganese, boron, zinc, copper, molybdenum, chlorine, sodium, cobalt, silicon, and nickel.
Hormones

Plant hormones may be used to affect plant processes.

Non-limiting examples of plant hormones that are useful in embodiments of the subject invention include but are not limited to, auxins (such as heteroauxin and its analogues, indolylbutyric acid and a-naphthylacetic acid), gibberellins, and cytokinins.
Biostimulants

Biostimulants are material which contains substance(s) and/or microorganisms that stimulates natural processes into the plant. Biostimulants helps increasing nutrient uptake, nutrient use efficiency, tolerance to abiotic stress, and/or crop quality, regardless of its nutrient content

Non-limiting examples of structural materials of the present invention are materials that give the structure of the system for example water, aerogels, treated starch, treated cellulose, polymers, superadsorbents and the functional materials are the materials consumed by the plant for example, a fertilizer compound.

Each embodiment disclosed herein is contemplated as being applicable to each of the other disclosed embodiments. Thus, all combinations of the various elements described herein are within the scope of the invention.

The controlled release mechanism embodied in the agrochemical delivery units described herein are advantageous over controlled release mechanisms used in agrochemical delivery systems currently available in the art for a number of reasons.

Current controlled release mechanism of agrochemical is based mainly on fully encapsulation of fertilizer (e.g. Agrium, ICL, Kingenta and Ekompany) or pesticides (e.g. Adama, Syngenta, Bayer). Fully encapsulation of fertilizer is usually based on resins (e.g. polyurethanes) or sulfur base mixture. Pesticides are loaded into micro polymeric capsules. Products of encapsulated fertilizer are limited to milligrams scale of dry fertilizer, due to the need of thick wall opposing the high inner pressure. This pressure is build up due to water entering the capsule driven by the negative osmotic potential of the dissolve fertilizer. As more fertilizer is encapsulated, more pressure will build up and a thicker wall is required. The feasible ratio between fertilizer amounts to wall thickness is in the tens of milligrams scale. Nevertheless encapsulated fertilizer is still very expensive and costs up to four times over the fertilizer price.

Moreover, the release mechanism is based on transport through faults and cracks distributed in the casing. Meaning, coating must be uniform throughout the all surface area, which is in turn a manufacturing challenge.

On top of that, the materials being used for coating are temperature sensitive and change their structural properties extremely in small temperature range (17° C.-25° C.), leading to radical changes in release rates (up to double the rate). Pesticide's encapsulation is subject to the same challenges: uniform coating and temperature dependent.

The subject invention successfully overcomes these drawbacks mentioned above by:
coating more than 99.9% of the agrochemical's surface area with cheap water impermeable materials and focus on controlling the release via the less than 0.1% left, and
providing a novel mechanism which allows water diffuse into the agrochemical with minimal pressure build up (few cm) and the need of thick wall opposing it.

The outcome of above two innovations allows production of a high load (grams scale) controlled release mechanism where:
the materials comprising the new mechanism are not susceptible to temperature alterations, and
the estimated cost of the new mechanism is only about 10% over the agrochemical's price.

All publications and other references mentioned herein are incorporated by reference in their entirety, as if each individual publication or reference were specifically and individually indicated to be incorporated by reference. Publications and references cited herein are not admitted to be prior art.

This invention will be better understood by reference to the Experimental Details which follow, but those skilled in the art will readily appreciate that the specific experiments detailed are only illustrative of the invention as defined in the claims which follow thereafter.

Experimental Details

Examples are provided below to facilitate a more complete understanding of the invention. The following examples illustrate the exemplary modes of making and practicing the invention. However, the scope of the invention is not limited to specific embodiments disclosed in these Examples, which are for purposes of illustration only.

### NON-LIMITING ILLUSTRATIVE EXAMPLES

### Example 1

### Fiber Count—Potassium Release Rate in Water

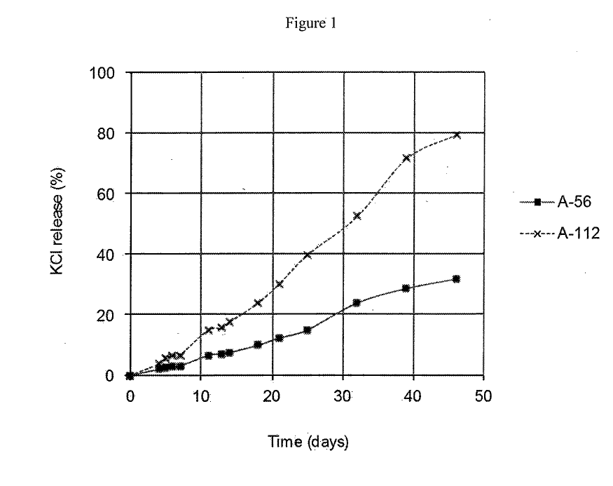

A 3×3.5 cm rectangular sachet was prepared by sealing (ME-300HI, 500W manual impulse sealer, Mercier Corporation, Taiwan) a potassium chloride (KCl) in Bioflex films. Prior to the final sealing, sachet was prepared with 56 fibers (A-56) and with 112 fibers (A-112) of 12 mg per meter cotton mesh fiber was incorporated into the sachets so that water is allowed to flow in and out of the sealed sachet. The sachet was dipped into 250 ml deionized water beaker. FIG. 1 presents the measurements of the potassium concentration as released from the sachets. A controlled release of potassium ions to water is evident with the number of fibers controlling the release rate from the sachet. After 40 days, the A-112 sachet had released about 70%, whereas the A-56 sachet had released about 30% of the potassium.

### Example 2

### Fiber Density—Potassium Release Rate in Water Through a Fiber With Variable Densities

A ˜5 cm isosceles right-angled triangle sachet was prepared by sealing a KCl paste in Bioflex films. A single cotton fiber with various density was incorporated into each sachet so that water are allowed to flow in and out of the sealed sachets (ME-300HI, 500W manual impulse sealer, Mercier Corporation, Taiwan). Fiber densities used were: 60 mg (Colored bird, China), 70 mg (DMC Ltd., UK), 90 mg (HEMA B.V., The Netherlands) and >300 mg (Shanghai Channelmed, China) per meter fiber. The sachet was dipped into 250 ml deionized water beaker. FIG. 2 presents the measurements of the potassium concentration as released from the sachet. A controlled release of potassium ions to water is evident with density of fibers controlling the release rate from the sachet. For example, the A-300 (>300 mg/meter) fiber released 60% after about 20 days.

### Example 3

### Hydrogel Incorporation—Potassium Release Rate in Water

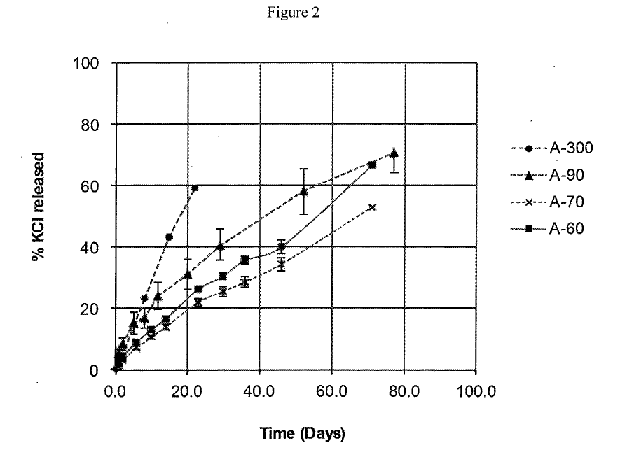

A —3×3.5cm rectangular sachet was prepared by sealing a KCl powder in Bioflex films. 112 fibers (A-112) of 12 mg per meter cotton mesh fiber were incorporated into the sachet (Sample A) so that water is allowed to flow in and out of the sealed sachet. A second sachet was prepared and then dipped into a polymerization solution containing Acrylic acid: Acryl amide: Bis-acryl amide (2:8:0.01) for 1 hour at 80° C. in order to polymerize the hydrogel so that the fibers are incorporated into an external hydrogel (Sample B, A-112 HG). Both sachets were dipped into 250 ml deionized water beaker. Potassium concentration as released from the sachet is shown in FIG. 3. A controlled release of potassium ions to water is evident with number of fibers controlling the release rate from the sachet with minor effect of exposing the sachet to the polymerization process. After about 40 days, Sample A had released about 70+%, whereas Sample B had released about 80%.

### Example 4

### Wet and Dry Fertilizer—Potassium Release Rate in Soil

A ˜3×3.5cm rectangular sachet was prepared by sealing a fertilizer (potassium chloride-KCl) powder (A-56D) (Sample A) and a KCl paste (A-56W) (Sample B) in Bioflex films. Fifty six fibers of 12 mg per meter cotton mesh fiber were incorporated into the sachet so that water is allowed to flow in and out of the sealed sachet. Each sachet was covered ˜20 cm below the soil surface of a 1500 ml container with a bottom drainage hole. A total of 1.5 Kg sea sand soil was loaded to each container. The container was irrigated with 50 ml deionized water on a daily bases.

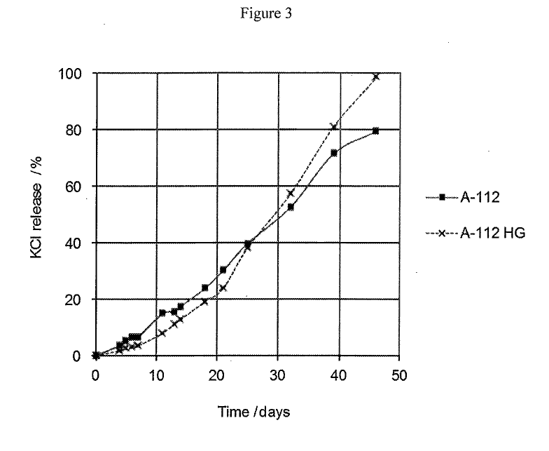

The water was collected, and the water volume and concentration of potassium were measured. The percent of released fertilizer was calculated. FIG. 4 presents the measurements of the potassium concentration as released from the sachet. A controlled release of potassium ions to irrigated soil is evident with the initial sachet water content controlling the lag time to release and the initial release rate from the sachet. Sample B, initially containing the paste exhibited a more rapid release, whereas Sample A exhibited a lag time of about 20 days.

### Example 5

### Fertilizer Amount—Potassium Release Rate in Water

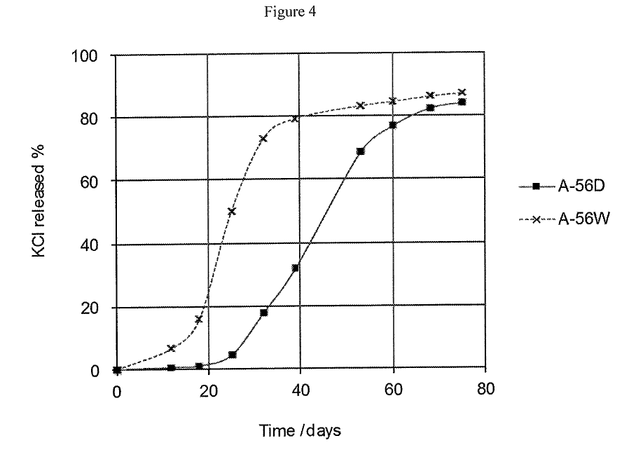

A ˜5 cm isosceles right-angled triangle sachet was prepared by sealing 1.1 (A-60-1.1) and 2.2 gram (A-60-2.2) KC1 pastes in Bioflex films. A single cotton fiber of 60 mg per meter was incorporated into the sachet so that water is allowed to flow in and out of the sealed sachet. The sachet was dipped into 100 ml deionized water beaker. FIG. 5 presents the measurements of the potassium concentration as released from the sachet. A controlled release of potassium ions to water is evident with the sachet content controlling the relative release rate from the sachet. The fertilizer amount did not affect the absolute release rate of the fertilizer.

### Example 6

### Fertilizer Mixture—Potassium Release Rate in Water

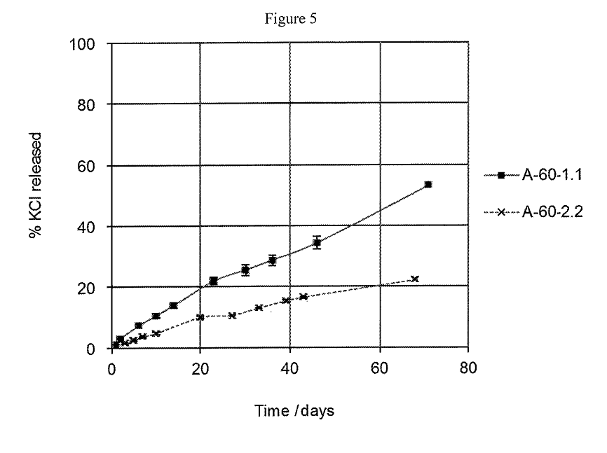

A ˜5 cm isosceles right-angled triangle sachet was prepared by sealing (A) 1.2 g potassium chloride paste (A-60-K) and different mixtures of potassium chloride: (B) with 1.5 gram Urea (A-60-NK) and (C) 1.2 gram KH₂PO₄ (A-60-PK) in Bioflex films. A single cotton fiber of 60 mg per meter density was incorporated into the sachet so that water is allowed to flow in and out of the sealed sachet. The sachet was dipped into 100 ml deionized water beaker. FIG. 6 represents the measurements of the potassium concentration as released from the sachets. A controlled release of potassium ions to water is evident with the sachet mixtures content controlling the relative potassium chloride release rate from the sachet. The rate of potassium release was highest in Sample B and lowest in Sample C.

### Example 7

### Fiber Count—Potassium Release Rate in Soil

A sachet filled with Potassium Chloride (KCl) and cotton fiber net dipped in Hydrogel was placed in a 1500 ml column filled with inert dune sand. The column was watered from the top. Effluents were drained, collected from the bottom, and analyzed for Potassium content.

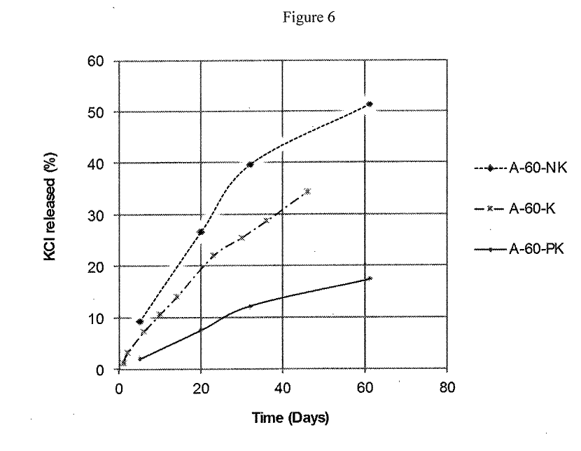

A ˜3×3.5cm rectangular sachet was prepared by sealing KCl powder in Bioflex films. (A) 56 fibers (A-56D) and (B) 112 fibers (A-112D) of 12 mg per meter cotton mesh fiber were incorporated into the sachet so that water is allowed to flow in and out of the sealed sachet. The column was irrigated with 50 ml deionized water on a daily basis. The percent of released fertilizer was calculated. FIG. 7 presents the measurements of the potassium concentration as released from the sachets. A controlled release of potassium ions to irrigated soil is evident with number of fibers controlling the release rate from the sachet. The 112 fiber sample released potassium more rapidly.

### Example 8

### Release Rate Over Time Under Variable Soil Moisture

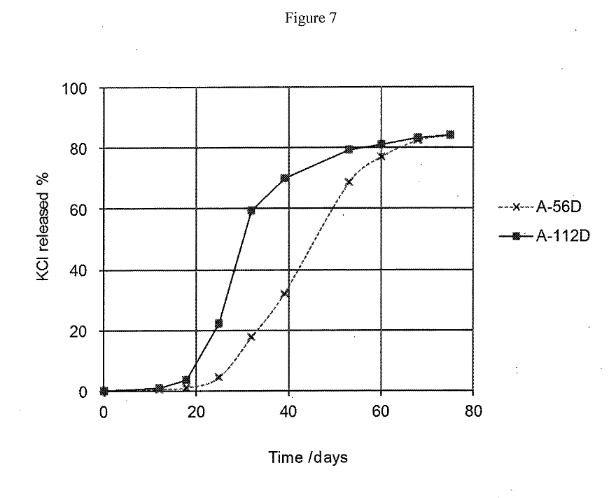

FIG. 8A describes the released rate of nitrogen (N) and potassium (K) as a function of time from A-56D samples (Same method as example 7). Watering and drainage collection were on a weekly basis. Equal released rates were measured for the K and N, about 1.25% per day.

FIG. 8B presents the release rate of potassium (K) over time under variable watering regime altering soil moisture.

### Example 9

A ˜3×3.5cm sachet incorporated with 15 cotton fibers mesh. The sachet contained N-P-K fertilizer; 1 gram Urea, 0.6 gram KH2PO4 and 0.68 gram KCl. Hydrogel was soaked into the fibers. The sachet was placed into a transparent container. Root penetration was monitored over time. Roots penetrated 10 days after germination. See FIG. 9.

### Example 10

### Unit Example

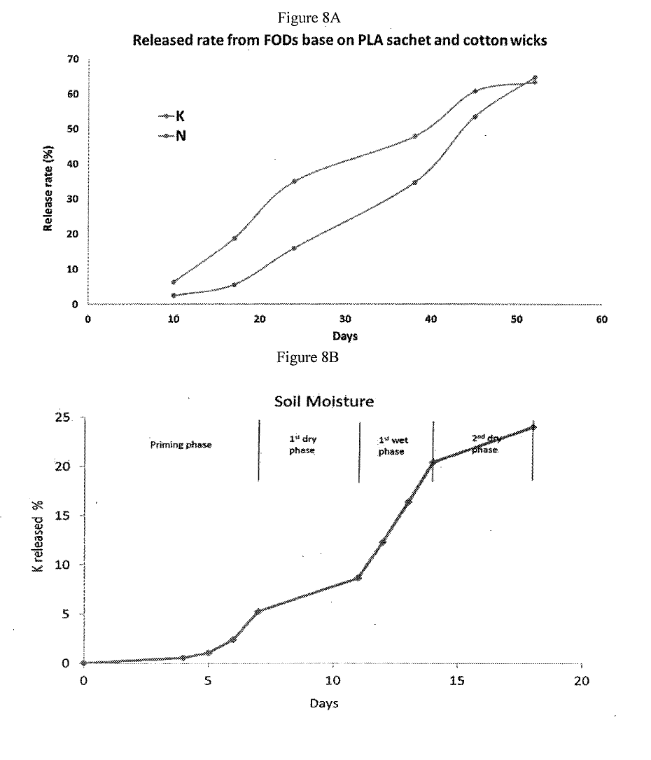

A rectangular sachet with Potassium Chloride fertilizer and cotton fiber net. See FIG. 10.

### Example 11

### Unit Example

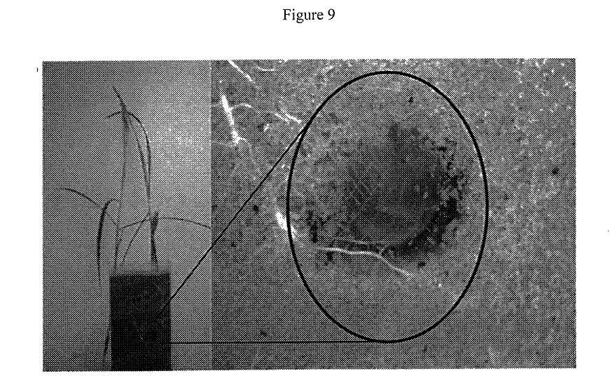

Triangular sachet filled with Urea and a single cotton wick. See FIG. 11.

### Example 12

### Unit Example

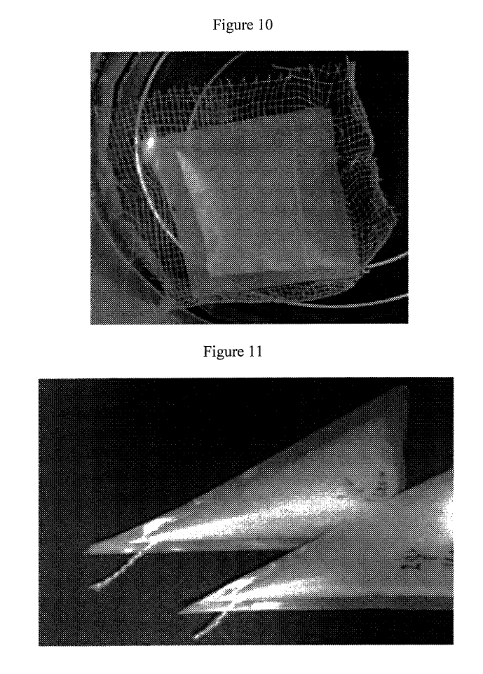

Sachet filled with Potassium Chloride fertilizer and cotton fiber net dipped in Hydrogel. See FIG. 12.

### Example 13

### Unit Example

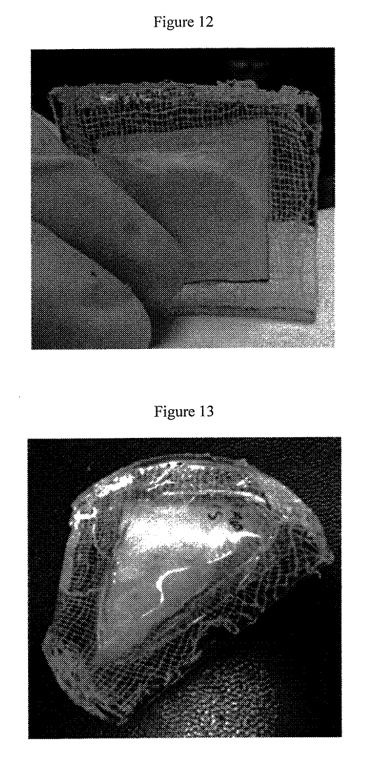

Sachet filled with Diammonium Phosphate and cotton fiber net dipped in Hydrogel. See FIG. 13.

### Example 14

### Unit Example

A sachet of about 2×1×1 cm is prepared by sealing 2-4 g of a fertilizer mixture (e.g., potassium chloride, urea, mono Ammonium phosphate, diammonium phosphate, ammonium sulfate, superphosphate, calcium nitrate, potassium nitrate) in a poly lactic acid sheet that is then soaked in a polymerizing hydrogel based on e.g., acrylic acid and carboxyl methyl cellulose. The sachet is applied to soil at a density of about 25-30 sachet units per square meter and approximately within the upper 30 cm of the soil or within the root zone.

The following materials were used in the above samples: Poly lactic acid sheets (PLA) refer to 50 mm thickness Bio-flex F-2110 films (FKuR Kunststoff GmbH, Germany). Sealing machine model used is ME-300HI, 500W manual impulse sealer (Mercier Corporation, Taiwan). Acrylic Acid, AA (Sigma Aldrich #147230), N-Hydroxyethyl acrylamide, HEAAm (Aldrich #697931), Acrylamide (AAm), (Acros #164830025), N-N methylene bis acrylamide, Bis-AAm, Sigma Aldrich #146072), Carboxymethylcellulose, Sodium salt, CMC, Mw=90K (Sigma Aldrich #419273), Sodium persulfate (Sigma Aldrich #216232) were all used as supplied. Potassium chloride (KCl), Diammonium phosphate (NH₄)₂HPO4) and urea were supplied by Chen Shmuel Chemicals, Israel.

Trials description and analysis:
Conduit types
   Hydrogel (capillary)
   Hydrogel integrated into uniform porous media (silica or ceramic plate)
   Hydrogel integrated into oriented porous media (wick)
Agrochemical loads
   High load
   Low load

Conduit Types:

Preparation: An impermeable cell, 1.1 cm diameter by 2 cm length cylinder, made of polypropylene was load with 2 grams of Potassium Chloride (KCl) in 10% humidity. Two hollow capillaries, 1 cm diameter by 1 cm length, were attached to the cell. Capillaries were filled with Acrylic Acid (AA)/CarboxyMethyl Cellulose (CMC) base hydrogel, generating two conduits. Similarly, capillaries were filled with 12 mg of 60 μm silica oxide particles prior hydrogel fill.

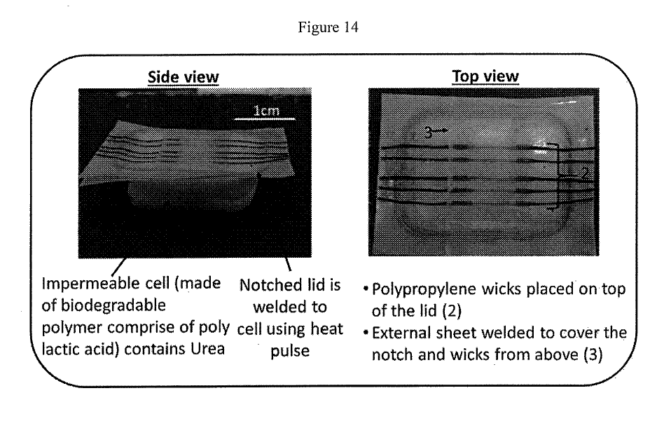

A ceramic plate, 1.5 cm in diameter and 0.7 cm in height, porosity of 50% and average pore size of 6 μm was soaked with the AA/CMC hydrogel. Afterward, it was attached to an impermeable cell, 1.3 cm diameter by 1.5 cm length cylinder, made of polypropylene. The cell was load with 2 grams of KC1 in 10% humidity. A 4 ml impermeable cell, made of biodegradable polymer sheet contains Poly Lactic Acid (PLA), was filled with 3.8 g of KCl or (NH₄)₂SO₄/(NH₄)₂HPO₄ mixture in 10% humidity. Subsequently, the cell was sealed with a cover made from the same sheet, which include a 6mm wide by 15mm long opening. Eight to five polypropylene wicks, 2.5cm long 80 μm in diameter, made of 100 non-woven filaments, were soaked with AA/CMC hydrogel and laid on top of the cover, across the opening. A 12mm wide patch of the same polymer sheet welded externally, that the wicks a cross the opening (see FIG. 14).

Analysis: Four samples of each type was put in a glassware with 100 ml of deionized water in control standard conditions. Potassium concentration was measured in water after 10-30 days.

Release rate was calculated per sample.

Meaning, all type of conduits may serve to release both fertilizer and plant protection products/plant growth enhancer.

Agrochemical Loads:

Preparation: An impermeable cell, made of biodegradable polymer sheet containing PLA, was filled with 1 or 4 g of KCl in 10% humidity. Subsequently, the cell was sealed with PLA sheet cover, which include a 6mm wide by 15mm long opening. Five polypropylene wicks, 2.5 cm long 80 μm in diameter, made of 100 non-woven filaments, were soaked with AA/CMC hydrogel and laid on top of the cover, across the opening. A 12 mm wide PLA polymer patch welded the wicks a cross the opening (see FIG. 14).

Analysis: Four samples of each load was put in a glassware with 100 ml of deionized water in control standard conditions. Potassium concentration was measured in water after 5-11 days.

Release rate calculated per sample is shown in the table below:

| | Release rate 5 days | Release rate 11 days |
|---|---|---|
| Agrochemical load | (g × d⁻¹) | (g × d⁻¹) |
| Low (1 gram of KCl) | 1.7 × 10⁻³-2.0 × 10⁻³ | 1.7 × 10⁻³-2.7 × 10⁻³ |
| high (4 gram of KCl) | 1.0 × 10⁻³-2.9 × 10⁻³ | 2.2 × 10⁻³-3.1 × 10⁻¹ |

What is claimed:

1. An agrochemical delivery unit comprising:
a) an impermeable cell which is a cell made of material that is impermeable to water;
b) an agrochemical within the impermeable cell; and
c) a wick comprising a hydrogel, said wick having a portion located within the impermeable cell and a portion located outside of the impermeable cell.

2. The unit of claim 1, wherein:
a) one or more portions of the wick are outside of the impermeable cell,
b) one or more portions of the wick are in contact with the agrochemical,
c) the unit comprises two or more separate impermeable cells,
d) the cell comprises two or more agrochemicals,
e) the unit comprises two or more separate impermeable cells and the same wick is in contact with the agrochemical in each different impermeable cell, such that a different portion of the wick is in contact with the agrochemical of each impermeable cell,
f) the unit is arranged so as to permit controlled release of the agrochemical through the wick from inside of the impermeable cell to media outside of the impermeable cell,
g) the agrochemical is released from the cell only through the wick,
h) the agrochemical is dry prior to use, or prior to use of the unit the agrochemical is a paste containing water, a solution, a concentrated solution, a saturated solution, or a dispersion,
i) the unit comprises one wick,
j) the unit comprises 2-20 wicks,
k) the wick comprises a fiber material,
l) the wick comprises a polyethelene, polypropylene, fiber mesh, cotton or other cellulose fiber, ceramic, or glass-based fiber, poly lactic acid,
m) the wick comprises a porous material possessing capillary structure,
n) the wick comprises a micro-porous material or macro-porous material,
o) the wick comprises fiber having a density of about 10-100 mg/meter,
p) the wick comprises about 1-500 fibers,
q) only a first portion of the wick comprises the hydrogel, preferably the first portion is outside of the cell, while a second portion of the wick does not comprise the hydrogel,
r) the wick comprises a different hydrogel at different portions of the wick, or
s) the wick is saturated with or coated by the hydrogel.

3-25 (canceled)

26. The unit of claim 1, wherein:
a) the material of the cell comprises: (a) one or more of polyethylene, polypropylene, or polyester, (b) comprises one or more of a polylactic acid, a polyhydroxyalkanoate, a polyhydroxybutyrate, or a polyhydroxyvalerate, (c) a thermoplastic starch, cellulose acetate, or other cellulose-based material, or (d) polycaprolactone, polyglycolide, polydioxanone, or any combinations or copolymers thereof,
b) the material of the cell comprises poly vinyl alcohol,
c) the material of the cell is a heat-sealable material, a biodegradable material, or a water soluble material, or
d) the cell comprises sheets each having a thickness of 10-100 micrometers.

27-42. (canceled)

43. The unit of claim 1, wherein each parameter of the wick can be adjusted to accomplish a desired release profile, wherein the parameter of the wick is length, width, material, density, and/or number of the wick.

44. (canceled)

45. (canceled)

46. (canceled)

47. An agrochemical delivery unit comprising:
a) a cell comprising two or more cell wall segments wherein at least one segment is impermeable to water and at least one segment is permeable to water; and
b) an agrochemical within the cell.

48. The unit of claim 47, wherein:
a) the agrochemical is released from the cell only through the permeable segment of the cell,
b) unit comprises two or more cells,
c) the unit comprises two or more agrochemicals, or
d) the permeable segment of the cell comprises micro-porous or macro-porous material.

49. (canceled)

50. The unit of claim 47, wherein the unit is arranged so as to permit controlled release of the agrochemical through the at least one permeable segment of the cell from inside the cell to media outside of the cell.

51. The unit of claim 47, wherein the agrochemical is dry prior to use, or prior to use of the unit the agrochemical is a paste containing water, a solution, a concentrated solution, a saturated solution, or a dispersion.

52. (canceled)

53. (canceled)

54. The unit of claim 47, wherein the permeable segment comprises hydrogel.

55. The unit of claim 54, wherein the hydrogel comprises a super absorbent polymer (SAP).

56. The unit of claim 55, wherein the SAP comprises:
a. a natural super absorbent polymer (SAP), a poly-sugar SAP, a semi-synthetic SAP, a fully synthetic SAP, or any combination thereof,
b. a synthetic hydrogel, a natural carbohydrate hydrogel, or a pectin or protein hydrogel, or any combination thereof, and/or
c. acrylamide, an acrylic derivative, or any combination thereof.

57. (canceled)

58. (canceled)

59. The unit of claim 47, wherein:
a) the agrochemical is released from the unit within 40 days when the unit is immersed in water at room temperature,
b) the agrochemical is released from the unit within 40 days when the unit is immersed in water at room temperature,
c) less than 20% by weight of the agrochemical is released from the unit within 40 days when the unit is immersed in water at room temperature,
d) less than 50% by weight of the agrochemical is released from the unit within 60 days when the unit is immersed in water at room temperature,
e) the agrochemical is released over a period of 1 month to 8 months, or
f) the agrochemical is released over a period a growing season of a crop.

60. (canceled)

61. The unit of claim 47, wherein each parameter of the at least one permeable segment can be adjusted to accomplish a desired release profile, wherein the parameter of the at least one permeable segment is the dimension, material, number, or percentage of the permeable segment.

62. (canceled)

63. The unit of claim 61, wherein the release profile of the one or more agrochemicals is adjusted only by the parameter of the permeable segment and/or wherein the release profile of the one or more agrochemicals is not affected by the amount of the one or more agrochemical inside the cell.

64. (canceled).

65. The unit of claim 47, wherein:
a) the volume of the cell is about 0.5-20 cm³,
b) the cell comprises 1-20 g of the one agrochemical,
c) the dry weight of the unit is about 0.1 g to 20 g,
d) the unit has a capacity of about 1-10 g of the agrochemical, and/or
e) the unit is in the shape of a cylinder, sphere, polyhedron, cube, or disc and/or the unit is in the shape having a cross section of a triangle, rectangle, circle, or square.

66. The unit of claim 47, wherein: (a) the agrochemical comprises at least one of a fertilizer, pesticide, hormone, drug, chemical growth agents, enzyme, growth promoter, biostimulant or microelement, and/or (b) the unit further comprises gel partially or completely surrounding the unit, wherein the gel is preferably formulated to contain one or more agrochemicals which are the same or different than the agrochemicals inside the cell of the unit.

67. An agrochemical delivery method comprising distributing a multitude of agrochemical delivery units of claim 47 to plant growth medium.

68. (canceled)

69. The method of claim 67, wherein:
a) the units are added at a depth of 1-50 cm, and/or
b) the units are added to the growth medium in a concentration of about 1-50, 5-50, or 10-30 units per square meter.

70. (canceled)

71. (canceled)

72. A process of making the agrochemical delivery unit of claim 1 comprising: creating a cell by encapsulating an agrochemical into a non-permeable polymeric cell equipped with a wick positioned party within and partly outside the cell such that the agrochemical is released through the wick in a controlled manner after it is in contact with water.

73-76. (canceled)

77. A process of making the agrochemical delivery unit of claim 47 comprising: (i) creating a cell comprising two or more cell wall segments wherein at least one segment is impermeable to water and at least one segment is permeable to water and (ii) encapsulating at least one agrochemical into the cell such that the at least one agrochemical is released through the at least one permeable segment of the cell in a controlled manner after it is in contact with water.
